(19) United States
(12) Patent Application Publication
(10) Pub. No.: US 2013/0182844 A1
(43) Pub. Date: Jul. 18, 2013

(54) TERMINAL APPARATUSES AND BASE STATION APPARATUS FOR TRANSMITTING OR RECEIVING A SIGNAL CONTAINING PREDETERMINED INFORMATION

(71) Applicant: SANYO ELECTRIC CO., LTD., Osaka (JP)

(72) Inventors: Makoto NAGAI, Kakamigahara (JP); Yoshihiro HORI, Gifu (JP)

(73) Assignee: SANYO ELECTRIC CO., LTD., Osaka (JP)

(21) Appl. No.: 13/691,096

(22) Filed: Nov. 30, 2012

Related U.S. Application Data
(63) Continuation of application No. PCT/JP2011/003056, filed on May 31, 2011.

(30) Foreign Application Priority Data
May 31, 2010 (JP) 2010-124967
Jun. 14, 2010 (JP) 2010-134941

(51) Int. Cl. H04L 29/06

(52) U.S. Cl. CPC H04L 63/0435
USPC 380/259

(57) ABSTRACT

When a first symmetric key table is received, a storage unit stores the received first symmetric key table that indicates a plurality of kinds of symmetric keys. The storage unit also stores beforehand a second symmetric key table in an area larger than an area where the first symmetric key table is usable. A determining unit determines whether or not a terminal apparatus is present within the area where the first symmetric key table is usable. When the terminal apparatus is determined to be present within the area, a verification unit generates a digital signature with a symmetric key contained in the first symmetric key table. When, on the other hand, the terminal apparatus is determined to be present outside the area, the verification unit generates the digital signature with a symmetric key contained in the second symmetric key table.

### BACKGROUND OF THE INVENTION

1. Field of the Invention

The present invention relates to a communication technology, and it particularly relates to a base station apparatus and terminal apparatuses for transmitting or receiving a signal containing predetermined information.

2. Description of the Related Art

Road-to-vehicle communication has been under investigation in an effort to prevent collision accidents of vehicles on a sudden encounter at an intersection. In a road-to-vehicle communication, information on conditions at an intersection is communicated between a roadside unit and an in-vehicle unit. Such a road-to-vehicle communication requires installation of roadside units, which means a great cost of time and money. In contrast to this, an inter-vehicular communication, in which information is communicated between in-vehicle units, has no need for installation of roadside units. In that case, current position information is detected in real time by GPS (Global Positioning System) or the like and the position information is exchanged between the in-vehicle units. Thus it is determined on which of the roads leading to the intersection the driver's vehicle and the other vehicles are located.

The wireless communications are more susceptible to the interception of communications than the wired communications and therefore the wireless communications have difficulty in ensuring the secrecy of communication contents. Also, when equipment is to be controlled remotely via a network, an unauthorized action may possibly be taken by a fake third party. In order to secure the secrecy of communication contents in the wireless communications, it is required that the communication data be encrypted and the keys used for encryption be updated on a regular basis. When an encryption key is to be updated, network apparatuses are each, for example, in an initial state where only data encrypted with an old encryption key prior to the updating can be transmitted and received. Then, each apparatus transmits from this initial state to a state where data encrypted with both the old encryption key and a newly updated encryption key can be transmitted and where the operation thereof is unknown as to the transmission and the receiving of data encrypted with the new encryption key.

Further, each apparatus transits to a state where the data encrypted with both the old encryption key and the new encryption key can be transmitted and received and where the operation concerning the transmission and the receiving of the data encrypted with the new encryption key has been determined. Finally, each apparatus transmits in sequence to a state where only data encrypted with the new encryption key after the completion of the updating of the key can be transmitted and received.

Used in wireless LANs (Local Area Networks) conforming to standards, such as IEEE 802.11, is an access control function called Carrier Sense Multiple Access with Collision Avoidance (CSMA/CA). In such a wireless LAN, therefore, the same wireless channel is shared by a plurality of terminal apparatuses. Such CSMA/CA is subject to conditions involving mutual wireless signals not reaching the targets, namely, carrier sense not functioning, due to the effects of distance between the terminal apparatuses or obstacles attenuating the radio waves and so forth. When the carrier sense does not function, there occur collisions of packets transmitted from a plurality of terminal apparatuses.

On the other hand, when a wireless LAN is applied to the inter-vehicular communication, a need arises to transmit information to a large indefinite number of terminal apparatuses, and therefore it is desirable that signals be sent by broadcast. Yet, at an intersection or like places, an increase in the number of vehicles, that is, the number of terminal apparatuses, is considered to cause an increase in the collisions of the packets therefrom. In consequence, data contained in the packets may not be transmitted to the other terminal apparatuses. If such a condition occurs in the inter-vehicular communication, then the objective of preventing collision accidents of vehicles on a sudden encounter at an intersection will not be attained. Further, when the road-to-vehicle communication is performed in addition to the inter-vehicular communication, the mode of communication becomes diversified. In such a case, it is required that the mutual effect between the road-to-vehicle communication and the inter-vehicular communication be reduced.

When the key is to be updated for encryption, the transition of a plurality of states used to be easy because the unicast communication was premised. When the broadcast communication is to be used, it is difficult to use a common encryption key if there are terminal apparatuses of different states. The updating of an encryption is desirable to ensure the security of communications. For an area where the possibility is high that there are many malicious users, the updating cycle of encryption key needs to be set a shorter value than that in an area where the possibility is low. Although it is preferably that the updating cycle of encryption key be made short in all area, the traffic may increase because of the distribution of new encryption keys. At the same time, it is required that the deterioration of frequency usage efficiency be suppressed.

### SUMMARY OF THE INVENTION

The present invention has been made in view of the foregoing circumstances, and a purpose thereof is to provide a technology of efficiently distributing encryption keys according to an area.

In order to resolve the above-described problems, a terminal apparatus according to one embodiment of the present invention includes: a storage unit configured to store a received first symmetric key table that indicates a plurality of kinds of symmetric keys, when the first symmetric key table is received, and configured to store in advance a second symmetric key table that is different from the first symmetric key table; a determining unit configured to determine whether or not the terminal apparatus is present within an area where the first symmetric key table stored in the storage unit is usable; a generator configured to generate a first packet with a symmetric key contained in the first symmetric key table stored in the storage unit, when the determining unit determines that the terminal apparatus is present within the area, and configured to generate a second packet with a symmetric key contained in the second symmetric key table stored in the storage unit, when the determining unit determines that the terminal apparatus is present outside the area; and a broadcasting unit configured to broadcast the first packet or the second packet generated by the generator.

Optional combinations of the aforementioned constituting elements, and implementations of the invention in the form of methods, apparatuses, systems, recording media, computer programs and so forth may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a structure of a communication system according to an exemplary embodiment of the present invention.

FIG. 2 shows a base station apparatus shown in FIG. 1.

FIG. 3 shows a format of MAC frame stored in a packet defined in the communication system of FIG. 1.

FIG. 4 shows a format of secure frame stored in a MAC frame defined in the communication system of FIG. 1.

FIG. 5 shows a data structure of a symmetric key table stored in a storage unit shown in FIG. 2.

FIG. 6 shows locations of base station apparatuses in the communication system of FIG. 1.

FIG. 7 shows a structure of a terminal apparatus mounted on a vehicle shown in FIG. 1.

FIG. 8 is a flowchart showing a procedure for transmitting packets in the base station apparatus of FIG. 2.

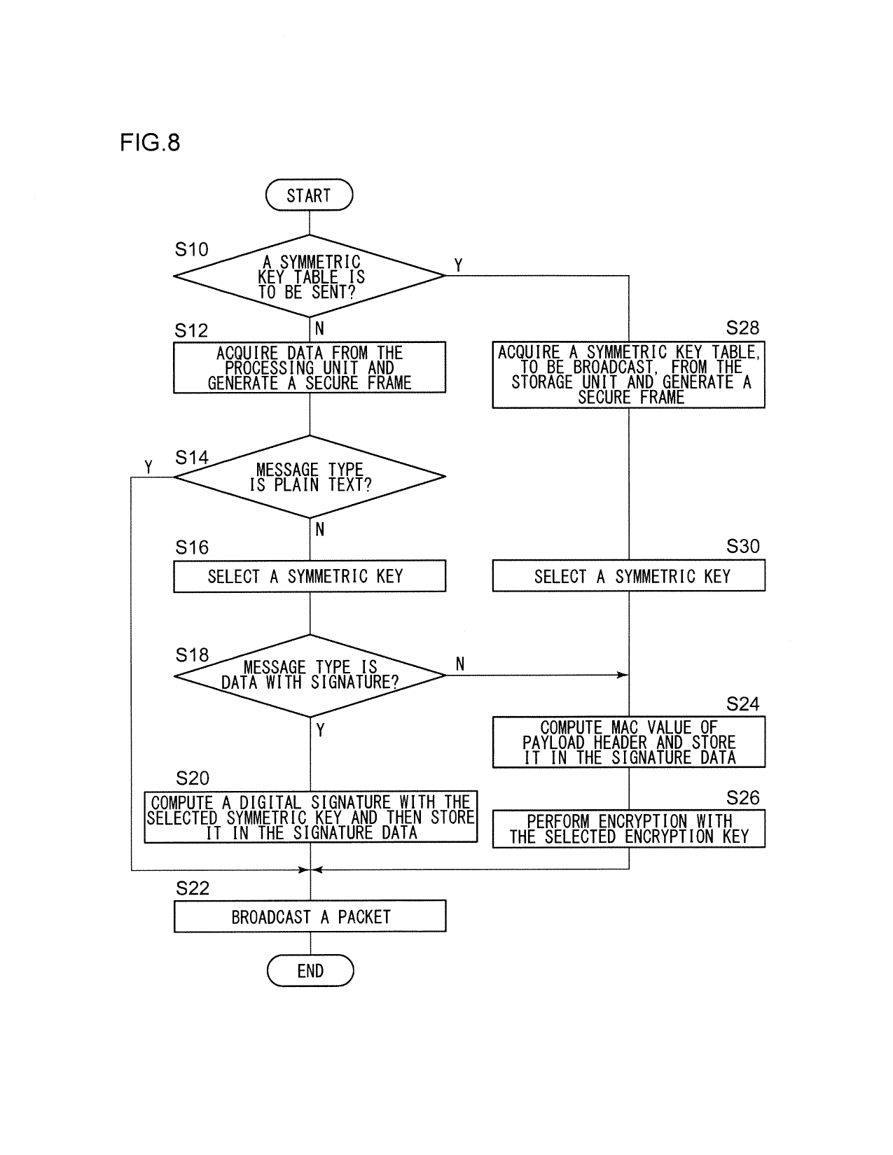

FIG. 9 is a flowchart showing a procedure for receiving packets in the base station apparatus of FIG. 2.

FIG. 10 is a flowchart showing a procedure for receiving packets in the terminal apparatus of FIG. 7.

FIG. 11 is a flowchart showing a procedure for transmitting packets in the terminal apparatus of FIG. 7.

FIG. 12 shows a format of secure frame stored in a MAC frame defined in a communication system according to a modification of an exemplary embodiment of the present invention.

FIGS. 13A and 13B show processing contents for the secure frame of FIG. 12.

FIG. 14 shows a data structure of a symmetric key table stored in a storage unit shown in FIG. 2.

FIG. 15 shows a structure of a terminal apparatus mounted on a vehicle shown in FIG. 1.

FIGS. 16A to 16C show brief overviews of the updating of a symmetric key table by a generator of FIG. 15.

FIG. 17 is a flowchart showing a maintenance procedure for a symmetric key table in the terminal apparatus of FIG. 15.

FIG. 18 is a flowchart showing a procedure for receiving packets in the terminal apparatus of FIG. 15.

FIG. 19 is a flowchart showing a procedure for transmitting packets in the terminal apparatus of FIG. 15.

### DETAILED DESCRIPTION OF THE INVENTION

The invention will now be described by reference to the preferred embodiments. This does not intend to limit the scope of the present invention, but to exemplify the invention.

The present invention will be outlined before it is explained in detail. Exemplary embodiments of the present invention relate to a communication system that carries out not only an inter-vehicular communication between terminal apparatuses mounted on vehicles but also a road-to-vehicle communication from a base station apparatus installed in an intersection and the like to the terminal apparatuses. As the inter-vehicular communication, a terminal apparatus transmits, by broadcast, a packet in which the information such as the traveling speed and position of its vehicle is stored (note that the transmission of packet(s) by broadcast is hereinafter called “broadcasting”, “being broadcast” or “by broadcast” also).

And the other terminal apparatuses receive the packets and recognize the approach or the like of the vehicle based on the data. As the road-to-vehicle communication, a base station apparatus transmits, by broadcast, a packet in which the intersection information, the traffic jam information, the security information, and the like are stored. For simpler explanation, the information contained in the packet used for the inter-vehicular communication and the road-to-vehicle communication will be hereinafter generically referred to as “data”.

The intersection information includes information on conditions at an intersection such as the position of the intersection, images captured of the intersection, where the base station apparatus is installed, and positional information on vehicles at or near the intersection. A terminal apparatus displays the intersection information on a monitor, recognizes the conditions of vehicles at or near the intersection based on the intersection information, and conveys to a user the presence of other vehicles and pedestrians for the purpose of preventing collision due to a right turn or a left turn at a sudden encounter at the intersection and the like so as to prevent the accidents. The traffic jam information includes information concerning the congestion situation near the intersection, where the base station apparatus is installed, and the information concerning road repairing and accidents that have happened. Based on such information, how much the road ahead may be congested is conveyed to the user or any possible detour is presented thereto. The security information includes information concerning the protection of data such as provision of a symmetric key table. Its detail will be discussed later.

To prevent the spoofing, use of a false identity and the like in such communications, digital signatures (digital signatures) are used. An encryption key is used to generate a digital signature. In the communication system according to the present exemplary embodiment, a symmetric key is used as an encryption key in consideration of the processing load. Also, a plurality of symmetric keys are used for the purpose of reducing the leakage risk of symmetric key. Each symmetric key is managed through each key ID, and a plurality of symmetric keys are put altogether in a symmetric key table. Symmetric key table IDs are assigned to the commonly key tables, so that a plurality of kinds of symmetric key tables are defined. In the communication system, a plurality of kinds of symmetric key tables are divided into a first symmetric key table group where a table usable area is limited to a certain area, namely, symmetric key tables are used in a predetermined area only, and a second symmetric key table group where the table usable area is unlimited, namely, symmetric key tables are used in an area outside the aforementioned predetermined area. Here, the first symmetric key table group is broadcast from a base station apparatus located within a usable area or a base station apparatus located surrounding the usable area. Upon receipt of a symmetric key table belonging to the first symmetric key group table, the terminal apparatus records the received symmetric key table if this received symmetric key table has not yet been stored therein. On the other hand, the symmetric key tables belong to the second symmetric key table has been stored beforehand in the terminal apparatus.

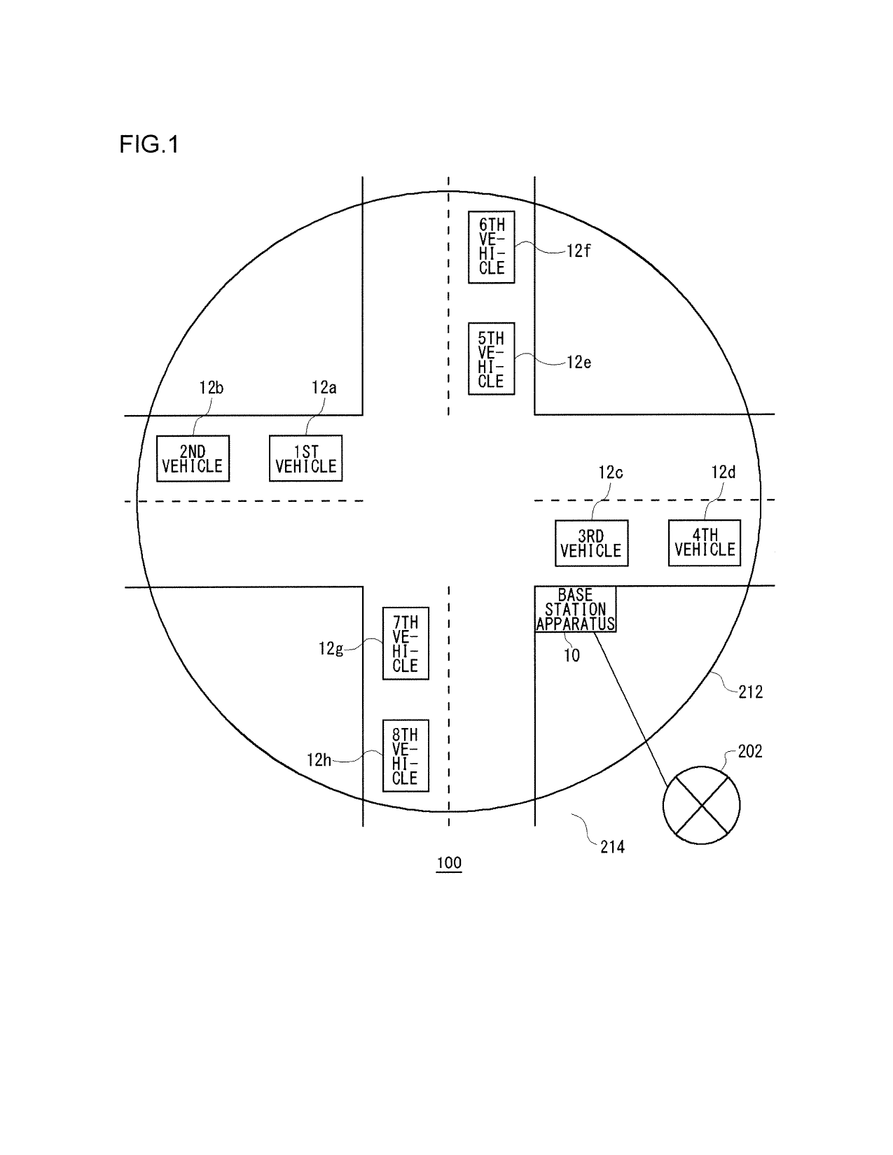

FIG. 1 shows a structure of a communication system 100 according to an exemplary embodiment of the present invention. FIG. 1 corresponds to a case thereof at an intersection viewed from above. The communication system 100 includes a base station apparatus 10, a first vehicle 12a, a second vehicle 12b, a third vehicle 12c, a fourth vehicle 12d, a fifth vehicle 12e, a sixth vehicle 12f, a seventh vehicle 12g, and an eighth vehicle 12h, which are generically referred to as “vehicle 12” or “vehicles 12”, and a network 202. It is to be noted that each vehicle 12 has a not-shown terminal apparatus installed therein.

As shown in FIG. 1, a road extending in the horizontal, or left-right, direction and a road extending in the vertical, or up-down, direction in FIG. 1 intersect with each other in the central portion thereof. Note here that the upper side of FIG. 1 corresponds to the north, the left side thereof the west, the down side thereof the south, and the right side thereof the east. And the portion where the two roads intersect each other is the intersection. The first vehicle 12a and the second vehicle 12b are advancing from left to right, while the third vehicle 12c and the fourth vehicle 12d are advancing from right to left. Also, the fifth vehicle 12e and the sixth vehicle 12f are advancing downward, while the seventh vehicle 12g and the eighth vehicle 12h are advancing upward.

A packet to which a digital signature (digital signature) is attached is broadcast in the communication system 100 to prevent the spoofing, use of a false identity and the like in such communications. The digital signature is a digital signature that is to be attached to an electromagnetic record such as data contained in the packet. This corresponds to a seal or signature in a paper document and is mainly used to authenticate a person's identity and to prevent the forgery and falsification. More specifically, when there is a person recorded in a document as a preparer of the document, whether the document is surely prepared by the person recorded in the document or not is certified, in the case of paper documents, by the signature or seal of the preparer. Since, however, the seal cannot be directly pressed against the electronic document or the signature cannot be written in the document, the digital signature serves its purpose of certifying this. To produce such digital signature, encryption is used.

A digital signature complying with a public key encryption scheme is effective as the digital signature. The digital signature scheme (digital signature scheme) is comprised of key generation algorithm, a signing algorithm, and a signature verifying algorithm. The key generation algorithm corresponds to an advance preparation of a digital signature. The key generation algorithm outputs a public key and a secret key (private key) of the user. A different random number is selected every time the key generation algorithm is executed and therefore a pair of a public key and a secret key is assigned to each user. Each user keeps the secret key, whereas the public key is open to the public.

A user who has signed the signature is called an authorized signatory of a signed document. When a signatory is to prepare a signed document using a signing algorithm, the signatory enters its secret key (private key) together with messages. Since the secret key of the signatory is only known to the signatory himself/herself, the secret key serves itself as a means for identifying the preparer of the message to which the digital signature has been attached. A user, namely a verifier, who has received the signed document, verifies whether the signed document is valid or not, by the use of the signature verifying algorithm. In so doing, the verifier enters a public key of the signatory into the signature verifying algorithm so as to verify whether the signed document is valid or not. The signature verifying algorithm determines if the signed document has been surely prepared by the user and then outputs its result.

The processing load of such a public key encryption scheme is large in general. Near an intersection, for example, the packets sent from 500 terminal apparatuses 14 may have to be processed during 100 msec period, for example. Also, about 100 bytes of data are stored in the packets broadcast from the terminal apparatus mounted on the vehicle 12. In contrast to this, about 200 bytes are required for the public key certificate and the digital signature in the public key encryption scheme, so that the transmitting efficiency may be significantly reduced. Also, the amount of computation for the verification of a digital signature in the public key scheme is large. Accordingly, if the packets sent from 500 terminal apparatuses 14 are to be processed during a period of 100 msec, a sophisticated encryption computing apparatus or controller will be required, thereby increasing the cost of the terminal apparatuses. RSA, DSA, ECDSA and the like are used as digital signature schemes based on the public key encryption scheme.

In order to cope with this problem, the digital signature with the symmetric key cryptosystem comes into service. In the symmetric key cryptosystem, the same value used for the encryption or a value easily derivable from the encryption key is used as a decryption key. A decryption key is known to a receiving-side terminal apparatus and therefore the certificate of the key is no longer required. As a result, the degradation of transmitting efficiency is suppressed as compared with when the public key encryption scheme is used. CBC-MAC is available as a digital signature scheme. Also, the processing amount for the symmetric key cryptosystem is smaller than that for the public key encryption scheme. A typical method used for the symmetric key cryptosystem is DES and AES. In the communication system 100, the symmetric key cryptosystem is used as the encryption scheme on account of the transmission load and the processing load.

If only a single type of symmetric key is used in the communication system 100, a malicious user may easily obtain the symmetric key. In order to cope with this, a plurality of symmetric keys are defined in advance in the communication system 100, and each symmetric key is managed through a symmetric key ID. Also, a plurality of symmetric keys are gathered together into a symmetric key table. Further, the symmetric key table is managed through the symmetric key IDs, and increasing the number of symmetric key IDs defines a plurality of commonly key tables. Assume hereinafter for the clarity of description that the terminal apparatus 14 uses two symmetric key tables that are a first symmetric key table belonging to the first symmetric key table group and a second symmetric key table belonging to the second symmetric key table group. Also, assume that a predetermined area, where the first symmetric key table is usable, is defined as a range where carrier signals from the base station apparatus 10 are receivable.

The first symmetric key table, for which a pre-selected base station apparatus 10 is assigned, is usable on the periphery of the assigned base station apparatus 10. The second symmetric key table, for which no particular base station apparatus is assigned, is used in an area where the first symmetric key table is not used. In this manner, the area in which the first symmetric key table is usable is restricted and therefore the terminal apparatus 14 does not need to hold the first symmetric key table constantly. Thus the first symmetric key table is provided when it is transmitted from the base station apparatus 10 located within a usable area or located on the periphery of the usable area. Since the second symmetric key table is used regardless of the area, the terminal apparatus 14 constantly holds the second symmetric key table.

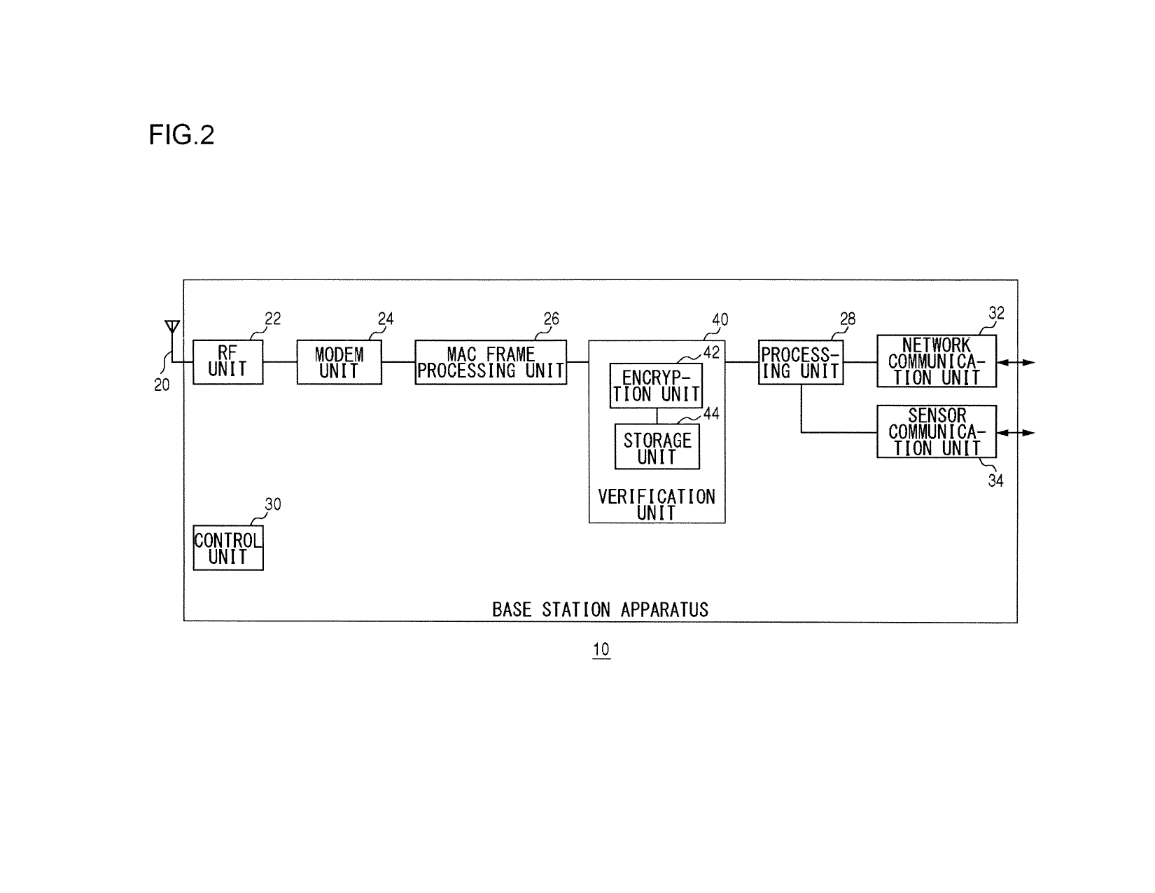

FIG. 2 shows the base station apparatus 10. The base station apparatus 10 includes an antenna 20, an RF unit 22, a modem unit 24, a MAC frame processing unit 26, a verification unit 40, a processing unit 28, a control unit 30, a network communication unit 32, and a sensor communication unit 34. The verification unit 40 includes an encryption unit 42 and a storage unit 44. The RF unit 22 receives, through the antenna 20, packets transmitted from terminal apparatuses and the other base station apparatuses (not shown), as a receiving processing. The RF unit 22 performs a frequency conversion on the received packet of a radiofrequency and thereby generates a packet of baseband. Further, the RF unit 22 outputs the baseband packet to the modem unit 24. Generally, a baseband packet is formed of an in-phase component and a quadrature component, and therefore the baseband packet should be represented by two signal lines. However, the baseband packet is here represented by a single signal line to make the illustration clearer for understanding. The RF unit 22 also includes an LNA (Low Noise Amplifier), a mixer, an AGC unit, and an A/D converter.

The RF unit 22 performs a frequency conversion on the baseband packet inputted from the modem unit 24 and thereby generates a radiofrequency packet as a transmission processing. Further, the RF unit 22 transmits, through the antenna 20, the radiofrequency packet in a road-to-vehicle transmission period. The RF unit 22 also includes a PA (Power Amplifier), a mixer, and a D-A converter.

The modem unit 24 demodulates the radiofrequency packet fed from the RF unit 22, as a receiving processing. Further, the modem unit 24 outputs a MAC frame obtained from the demodulation result, to the MAC frame processing unit 26. Also, the modem unit 24 modulates the data fed from the MAC frame processing unit 26, as a transmission processing. Also, the modem unit 24 modulates the MAC frame fed from the MAC frame processing unit 26, as a transmission processing. Further, the modem unit 24 outputs the modulation result to the RF unit 22 as a baseband packet. It is to be noted here that the communication system 100 is compatible with the OFDM (Orthogonal Frequency Division Multiplexing) modulation scheme and therefore the modem unit 24 performs FFT (Fast Fourier Transform) as a receiving processing and performs IFFT (Inverse Fast Fourier Transform) as a transmission processing also.

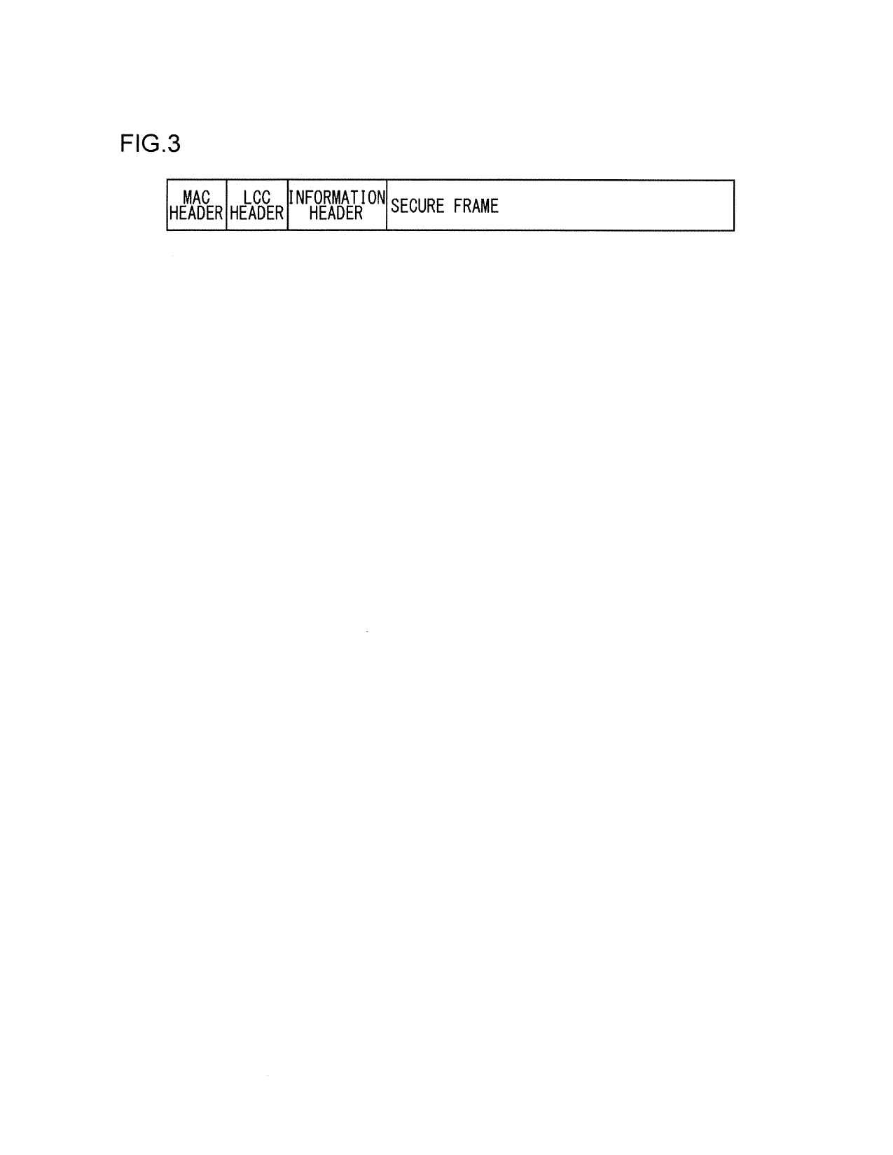

FIG. 3 shows a format of MAC frame stored in the packet defined in the communication system 100. Starting from the beginning, the MAC frame is constituted by “MAC header”, “LL header”, “information header”, and “secure header” in this order. Information concerning data communication control is stored in the MAC header, the LL header, and the information header, and the respective headers correspond to the respective layers of communication layer. Each feed length is as follows, for instance. The MAC header is of 30 bytes, the LLC header 8 bytes, and the information header 12 bytes. The secure frame will be discussed later. Now refer back to FIG. 2.

As a receiving processing, the MAC frame processing unit 26 retrieves the secure frame from the MAC frame fed from the modem unit 24 and outputs the secure frame to the verification unit 40. As a transmission processing, the MAC frame processing unit 26 adds the MAC header, the LLC header and the information header to the secure frame fed from the verification unit 40, generates a MAC frame, and outputs the MAC frame to the modem unit 24. Also, the timing control is performed so that the packets sent from the other base station apparatuses and terminal apparatuses do not collide with each other.

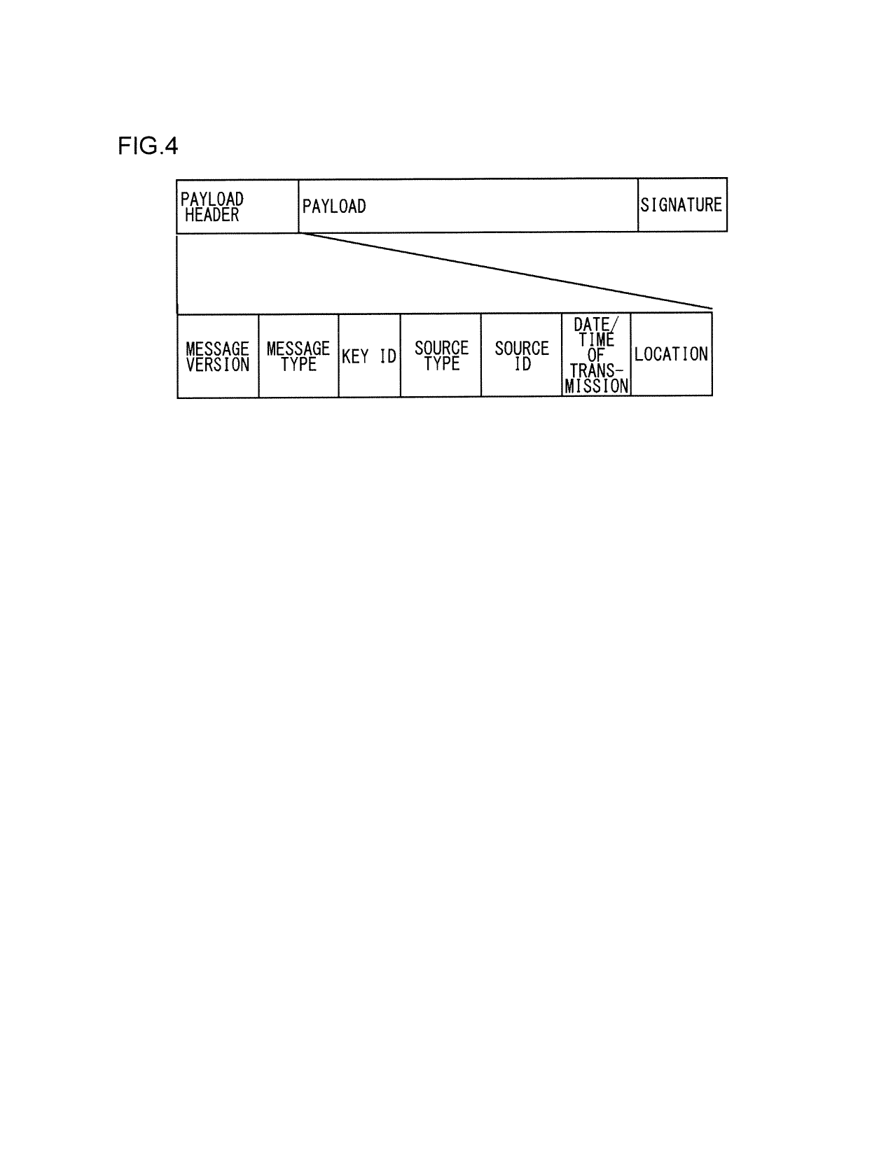

FIG. 4 shows a format of secure frame defined in the communication system 100. The secure frame is constituted by “payload header”, “payload”, and “signature”. The payload header is constituted by “message version”, “message type”, “key ID”, “source type”, “source ID”, “date/time of transmission”, and “location”.

Message version is identification information by which to specify the format of a secure frame. The message version is a fixed value in the communication system 100. The message type is information that defines an encryption processing for the payload. Here, it is assumed that plaintext data (=0), data with signature (=1), and encrypted data (=2) are set. The key ID is identification information by which a symmetric key used for the encryption of the digital signature or payload is identified, and is one for which the table ID and the symmetric key ID are connected. It is assumed herein that the source type ID sets the types of a sender of packets. That is, the source type ID sets is set to identify a base station apparatus 10 (=3), a terminal apparatus (=2) mounted on an emergency vehicle such as a fire-extinguishing vehicle and an ambulance vehicle (hereinafter referred to as “priority vehicle” also), a terminal apparatus (=1) mounted on other vehicles (hereinafter referred to as “ordinary vehicles” also), and a terminal apparatus (=0) mounted on a non-vehicle. The source ID is unique identification information by which a base station apparatus 10 or a terminal apparatus 14 that has transmitted the packet can be uniquely identified. If the sender is a base station apparatus, an base station ID described later will be stored.

The payload is a field that stores the aforementioned data, and corresponds to intersection information, road information and the like to be conveyed to the terminal apparatus. If the message type is data with signature (=1), the payload will be field that stores a digital signature for the payload header and the payload. When the message type is encrypted data (=2), this data may be regarded as invalid. However, it is assumed herein that stored are a fixed value, a value identifiable at a receiving side, such as a copy of a payload header portion, or a hash value (a computational result for a hash function) for a payload header and/or a payload before encryption, and a computable value at a receiving side, such as checksum and parity. Then, the payload and the signature are encrypted as a whole. By so doing, if the value stored in the decrypted signature agrees with a value identified at the receiving side or a computed value, the decryption will be done normally and therefore the validity of data stored in the payload or data stored in the payload and payload header can be verified. The payload is a field that stores the aforementioned data, and corresponds to intersection information, road information and the like to be conveyed to the terminal apparatus.

Each feed length is as follows, for instance. That is, the payload header is of 32 bytes, the payload is of 100 bytes (if broadcast from a terminal apparatus) or of 1K bytes (if broadcast from a base station apparatus), and the signature is of 16 bytes, for instance. In the communication system 100, AES (Advanced Encryption Standard) encryption is used as the encryption scheme. When the message type is data with signature, the digital signature is stored such that the MAC value evaluated by CBC-MAC (Cipher Block Chaining-Message Authentication Code) is stored in the signature. When the message type is encrypted data, the MAC value for the payload header is stored in the signature and then the payload and the signature are encrypted in a CBC (Cipher Block Chaining) mode. Now refer back to FIG. 2.

As a receiving processing, the verification unit 40 reads (interprets) the secure frame fed from the MAC frame processing unit 26 and outputs the data to the processing unit 28. Also, as a transmission processing, the verification unit 40 receives the data from the processing unit 28 and generates a secure frame and then outputs the secure frame to the MAC frame processing unit 26. Since the symmetric key cryptosystem is used in the communication system 100, the encryption unit 42 encrypts and decrypts the data using the symmetric key scheme. More specifically, when the message data type is data with signature, the signature is created; when the message data type is encrypted data, the encryption is done at the time when the secure frame is created whereas the data is decrypted at the time when the secure frame is read.

The storage unit 44 stores a symmetric key table that indicates a plurality of kinds of symmetric keys usable in the communication system 100. As described earlier, a plurality of symmetric key tables are defined and here the first symmetric key table and the second symmetric key table serve as the plurality of symmetric key tables. A plurality of symmetric keys usable for the communications in a limited area are contained in the first symmetric key table. A plurality of symmetric keys usable regardless of areas are contained in the second symmetric key table. This can be said that the second symmetric key table contains symmetric keys usable in areas where the first symmetric key table is not usable.

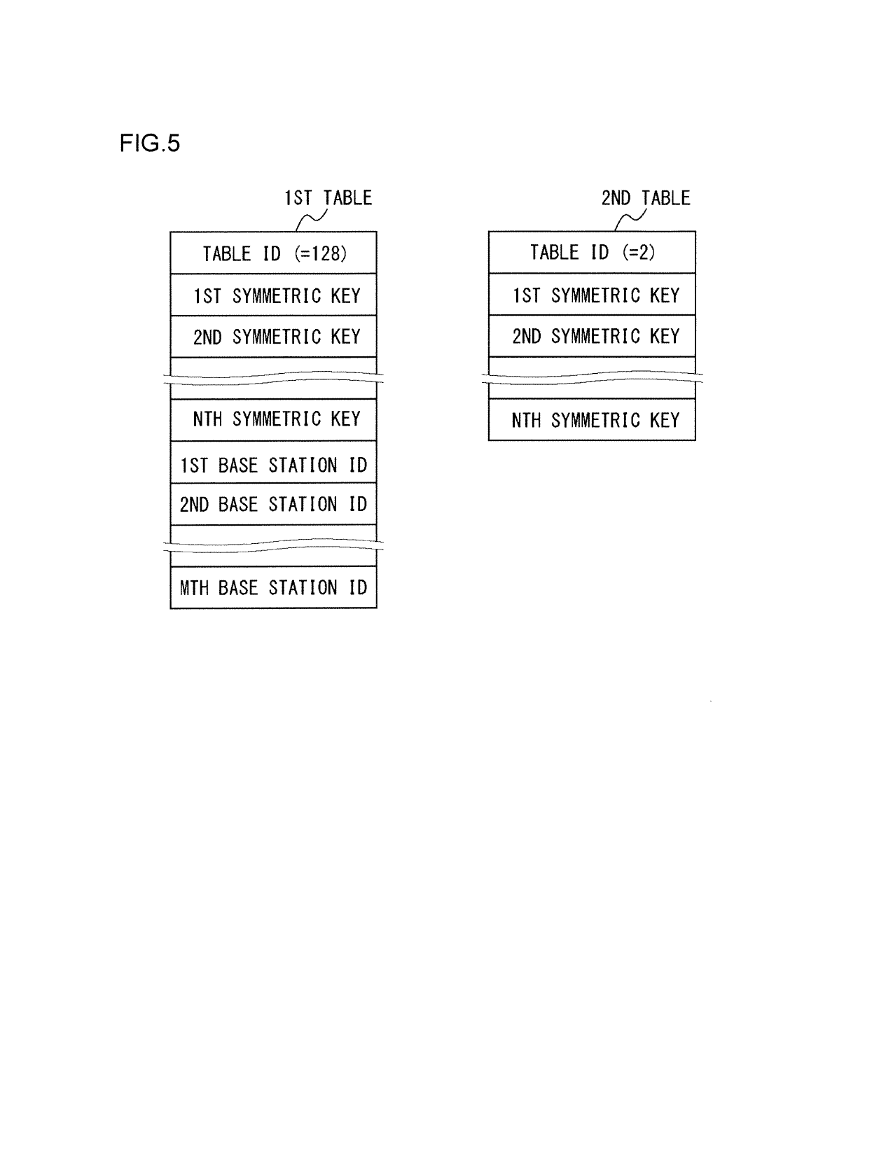

FIG. 5 shows a data structure of a symmetric key table stored in the storage unit 44. Symmetric key table IDs are given to the first symmetric key table and the second symmetric key table. In FIG. 5, the symmetric key table ID in a first table is “128”, and the symmetric key table ID in a second table is “2”. Each symmetric key table contains a plurality of symmetric keys, and each symmetric key is managed through a symmetric key ID. Each of the symmetric key tables shown in FIG. 5 contains N symmetric keys. The symmetric key ID of a first symmetric key is “1”, whereas the symmetric key ID of a second symmetric key is “2”. Accordingly, each symmetric key is identified by the combination of a symmetric key table ID and a symmetric key ID. Also, the first symmetric key table includes M base station IDs (M≧1) that indicate a limited area. The first symmetric key table is preferentially selected in an area where the carrier signals from the base station apparatuses 10 identified by the first to Mth base station IDs are receivable. The base station apparatus(es) that has/have transmitted the carrier signals can be identified through the base station IDs stored in the source ID of the secure frame. Now refer back to FIG. 2.

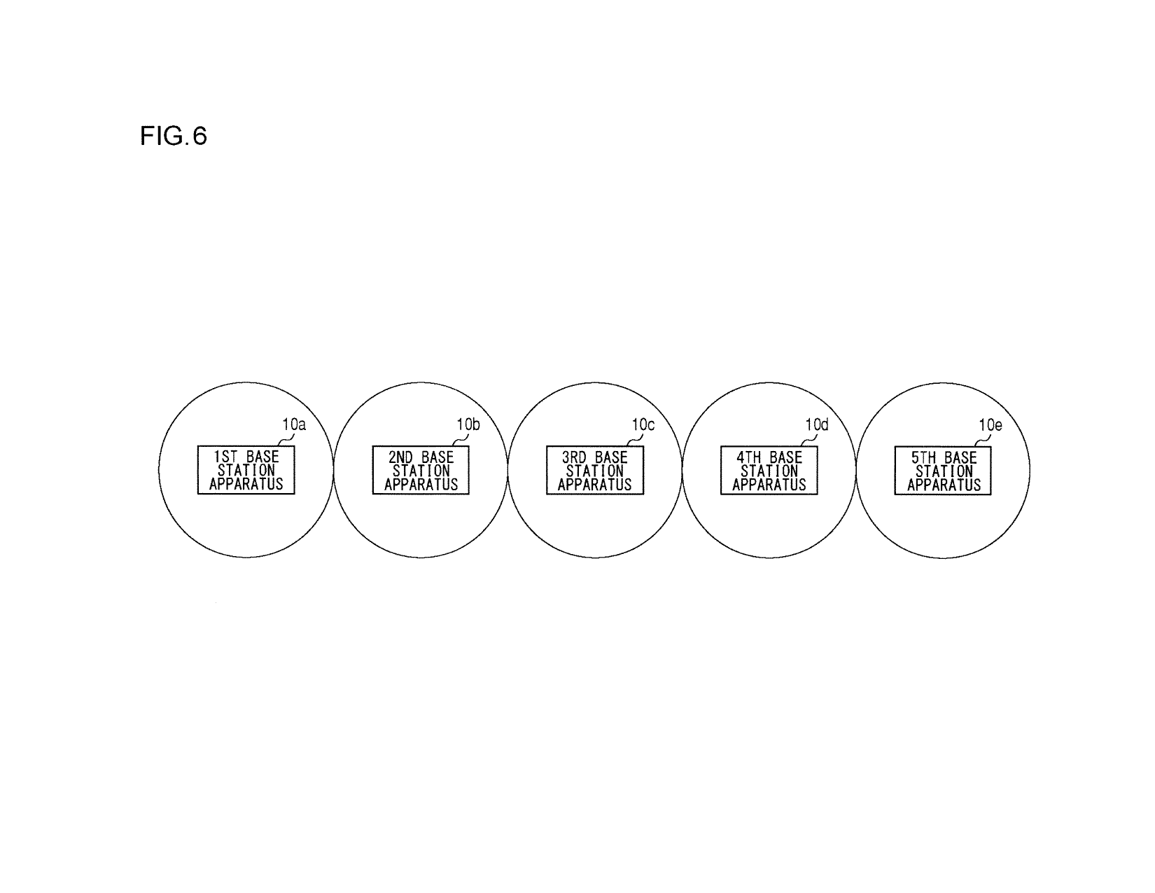

A description is now given of an area where the first symmetric key table is usable. For simpler explanation, assume that only one base station ID is contained in the first symmetric key table. FIG. 6 shows locations of base station apparatuses 10 in the communication system 100. For simplicity of explanation, let us assume a case where five base station apparatuses 10 are arranged side by side in a row in a unified manner. Here, these five base station apparatuses 10 are a first base station apparatus 10a, a second base station apparatus 10b, a third base station apparatus 10c, a fourth base station apparatus 10d, and a fifth base station apparatus 10e. A circle indicated surrounding each base station apparatus 10 corresponds to the area where the carrier signals of each base station are receivable. Here, the third base station apparatus 10c corresponds to the aforementioned base station apparatus 10, and the base station ID of the third base station apparatus 10c is contained in the first symmetric key table. Thus, a terminal apparatus, which has received the packets from the third base station apparatus 10c, enters an area formed by the third base station apparatus 10c, and uses the first symmetric key table when it broadcasts the packets.

If, on the other hand, a terminal apparatus does not receive the packets from the third base station apparatus 10c for a predetermined period of time or has received the carrier signals from the other base station apparatuses after it has exited from the area formed by the third base station apparatus 10c, this terminal apparatus will use the second symmetric key table when it broadcasts the packets. If, in FIG. 6, a terminal apparatus or terminal apparatuses is/are located within an area formed by the first base station apparatus 10a, an area formed by the second base station apparatus 10b, an area formed by the fourth base station apparatus 10d and an area formed by the fifth base station apparatus 10e or it/they is/are not located within any of these areas, this terminal apparatus or these terminal apparatuses will use the second symmetric key table when it/they broadcasts/broadcast the packets. Though its details will be discussed later, if a terminal apparatus receives the packets from the third base station apparatus 10c, the terminal apparatus will use the first symmetric key table; if it does not receive the packets from the third base station apparatus 10c, it will use the second symmetric key table. Now refer back to FIG. 2.

When the secure frame is to be generated, the verification unit 40 extracts a symmetric key by referencing the storage unit 44. For example, when this base station apparatus 10 corresponds to the third base station apparatus 10c of FIG. 6, the verification unit 40 randomly selects a single symmetric key from within the first symmetric key table. Also, when these base station apparatuses 10 correspond to the first base station apparatus 10a, the second base station apparatus 10b, the fourth base station apparatus 10d and the fifth base station apparatus 10e of FIG. 6, the verification unit 40 randomly selects a single symmetric key from within the second symmetric key table. If the message type is data with signature, the verification unit 40 will compute a digital signature for the payload header and the payload by the use of the selected symmetric key, at the encryption unit 42. If the message type is encrypted data, the payload and the signature will be encrypted at the encryption unit 42. If the message type is plaintext data, the verification unit 40 will output the generated secure frame to the MAC frame processing unit 26 as it is.

When reading the secure frame, the verification unit 40 references the key ID of the secure frame received from the MAC frame processing unit 26 and obtains a table ID and a symmetric key ID of a symmetric key to be used. Then, the verification unit 40 references the storage unit 44 and extracts a symmetric key identified by the key table ID and the symmetric key ID. Further, if the data format of the message type of the secure frame received from the MAC frame processing unit 26 is data with signature, the verification unit 40 will use the extracted symmetric key and thereby verify the validity of the signature. More precisely, the digital signature for the payload header and the payload is computed at the encryption unit 42, and the computed value is compared against the value of the digital signature stored in the signature of the secure frame received from the MAC frame processing unit 26. If the two values of the signatures agree with each other, it will be determined that the electronic signal is valid and that the information contained in the secure frame is information sent from a proper base station apparatus 10 or terminal apparatus 14, and the information will be outputted to the processing unit 28. If the two values of the signatures do not agree with each other, it will be determined that the digital signature is not valid, and therefore the data will be discarded. Also, if the message type is encrypted data, the payload and the signature will be decrypted at the encryption unit 42. Then, if the signature has a predetermined value, it will be determined that the data extracted from the secure frame has been normally decrypted, and the data extracted from the secure frame will be outputted to the processing unit 28. If, however, the signature does not have the predetermined value, the data will be discarded. The reason why an object to be encrypted is signature is as follows. It is because, as described earlier, a known value is stored in the signature and is to be encrypted and therefore the signature has a function in which whether the decryption has been performed normally at decryption or not is checked. If such a check function as this is not to be implemented, there is no need to encrypt the signature. If the message type is plaintext data, the data extracted will be outputted to the processing unit 28 without any preconditions.

The sensor communication unit 34 is connected to a not-shown internal network. Connected to the internal network are devices, for gathering the information on the intersections, such as a camera and a laser sensor (not shown) installed in each intersection. The devices, for gathering the information on the intersection, connected to the sensor communication unit 34 are generically referred to as “sensor” or “sensors”. The sensor communication unit 34 collects information obtained from the sensors installed in each intersection, via the network. The network communication unit 32 is connected to the not-shown network.

The processing unit 28 processes the data received from the verification unit 40. The processing result may be outputted to the network via the network communication unit 32 or may be accumulated internally and then outputted to the not-shown network at regular intervals. Also, the processing unit 28 generates data to be sent to the terminal apparatus 14, based on the road information (e.g., road repairing, congestion situation) received from the not-shown network via the network communication unit 32 and the information on the intersections gained from the not-shown sensors via the sensor communication unit 34. The control unit 30 controls the entire processing of the base station apparatus 10.

If this base station apparatus 10 is the third base station apparatus 10c of FIG. 6, the verification unit 40 will generate a security packet that contains the data acquired from the processing unit 28 with the first symmetric key table and then broadcast the generated security packet via the modem unit 24, the RF unit 22, and the antenna 20. Also, the verification unit 40 generates a security packet that contains the first symmetric key table stored in the storage unit 44 with the first symmetric key table, and broadcasts the generated security packet. In other words, the verification unit 40 of the base station apparatus 10, which forms the area where the first symmetric key table is usable, also broadcasts the first symmetric key table itself. Base station apparatuses 10 located adjacent to the base station apparatus 10 forming the area where the first symmetric key table is usable, which are, for example, the second base station apparatus 10b and the fourth base station apparatus 10d of FIG. 6, also broadcast the first symmetric key table itself, similarly to the third base station apparatus 10c. Here, a base station apparatus 10, which is located a predetermined distance away from the base station apparatus 10 forming the area where the first symmetric key table is usable, may also broadcast the first symmetric key table itself. Also, the respective verification units 40 of the first base station apparatus 10a, the second base station apparatus 10b, the fourth base station apparatus 10d, and the fifth base station apparatus 10e of FIG. 6 generate security packets that contain the data acquired from the processing units 28 with the first symmetric key table, and broadcast the generated security packets.

These structural components may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only or a combination of both.

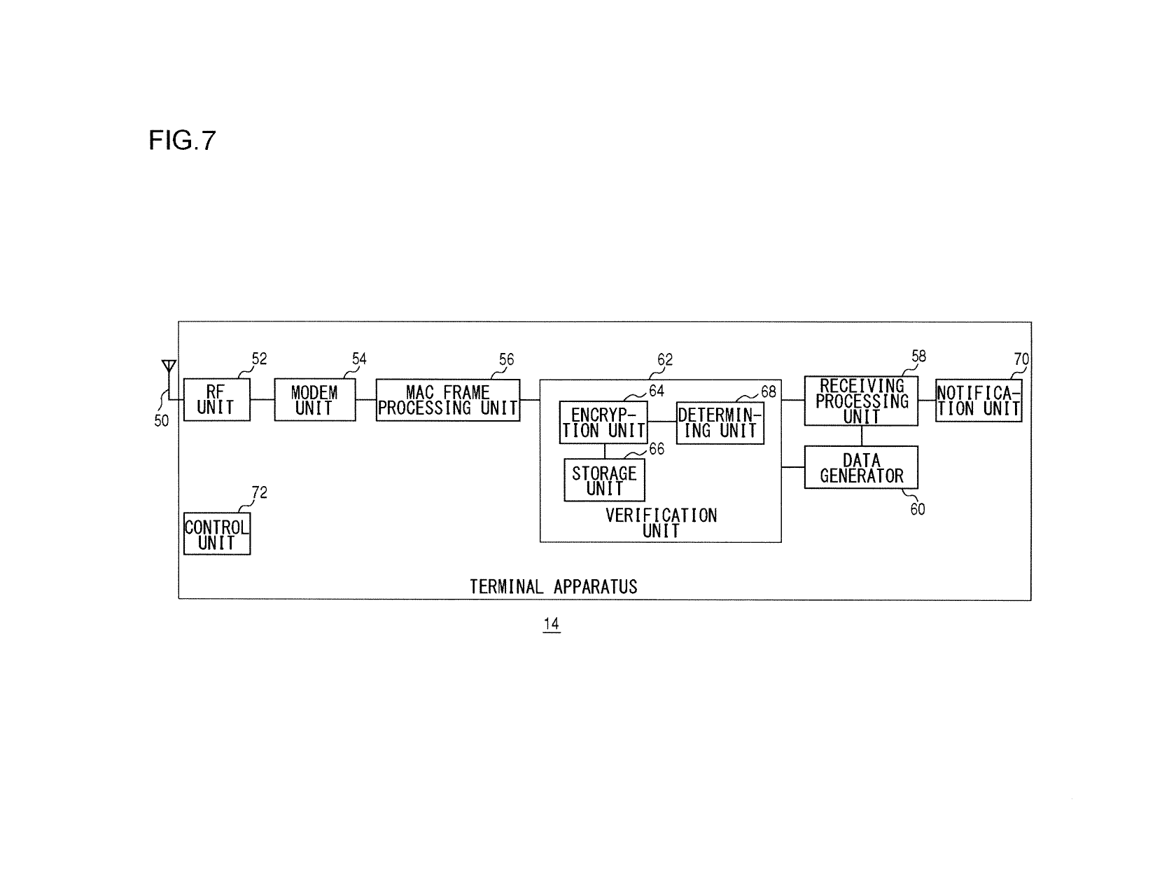

FIG. 7 shows a structure of a terminal apparatus 14 mounted on a vehicle 12. The terminal apparatus 14 includes an antenna 50, an RF unit 52, a modem unit 54, a MAC frame processing unit 56, a receiving processing unit 58, a data generator 60, a verification unit 62, a notification unit 70, and a control unit 72. The verification unit 62 includes an encryption unit 64, a storage unit 66, and a determining unit 68.

The antenna 50, the RF unit 52, the modem unit 54, the MAC frame processing unit 56, the verification unit 62, the encryption unit 64, and the storage unit 66 perform the processings similar to those of the antenna 20, the RF unit 22, the modem unit 24, the MAC frame processing unit 26, the verification unit 40, the encryption unit 42, and the storage unit 44 of FIG. 2, respectively. Thus, the description of the similar processings thereto is omitted here and a description is given centering around features different from those of FIG. 2.

Similar to the verification unit 40, the verification unit 62 generates and reads (interprets) a secure frame. If the payload of the received secure frame is security information, namely if it contains a first symmetric key table, and if the first symmetric key table is not yet recorded in the storage unit 66, the verification unit 62 will have the storage unit 66 store the received first symmetric key table therein. If there is free space in the storage unit 66, the received symmetric key table will be additionally recorded directly in the storage unit 66. If first symmetric key tables containing other table IDs are recorded, the first symmetric key table stored in the storage unit 66 will be rewritten. If a first common table having the same table ID as that of the received first common table is recorded in the storage unit 66, the received first common table will be discarded.

The receiving processing unit 58 estimates a crash risk, an approach of an emergency vehicle, such as a fire-extinguishing vehicle and an ambulance vehicle, a congestion situation in a road ahead and intersections, and the like, based on the data received from the verification unit 62 and the information on its vehicle received from the data generator 60. If the data is image information, the data will be processed so that it can be displayed by the notification unit 70.

The notification unit 70 includes notifying means such as a monitor, a lamp, and a speaker (not shown). The approach of other vehicles 12 (not shown) and the like are conveyed to a driver, via the monitor, the lamp and the speaker, according to instructions from the receiving processing unit 58. Also, the congestion information, the image information on the intersections and the like, and other information are displayed on the monitor.

As described earlier, the information with which to identify a base station apparatus 10 is stored in the “source ID” of the secure frame as the base station ID. If the sender of the packet is the base station apparatus 10, the determining unit 68 will extract the base station ID from the source ID and identify the base station apparatus 10 that has broadcast the packet.

Also, as described earlier, the first symmetric key table recorded in the storage unit 66 contains a list of base station IDs of the base station apparatuses that form the area where the first symmetric key table is usable. Here, the base station ID of the base station apparatus 10 corresponding to the third base station apparatus 10c of FIG. 6 is contained in the list. The determining unit 68 determines if the received base station ID is contained in the list stored in the storage unit 66. This corresponds to determining if a terminal apparatus is located within the area where the first symmetric key table is usable. The determining unit 68 holds the determination result. When generating a security frame, the verification unit 62 selects a symmetric key table based on the determination result obtained by the determining unit 68.

The data generator 60 includes a GPS receiver, a gyroscope, a vehicle speed sensor, and so forth all of which are not shown in FIG. 6. The data generator 60 acquires information on the not-shown its vehicle, namely the present position, traveling direction, traveling speed and so forth of the vehicle 12 that are carrying the terminal apparatuses 14, based on the information supplied from the components of the data generator 60. The present position thereof is indicated by the latitude and longitude. Known art may be employed to acquire them and therefore the description thereof is omitted here.

The data generator 60 generates data based on the acquired information, and outputs the generated data to the verification unit 62. Also, the acquired information is outputted to the receiving processing unit 58 as the information on its vehicle.

An operation regarding the transmitting/receiving of packets in the communication system 100 configured as above is now described. FIG. 7 is a flowchart showing a procedure for transmitting packets in the base station apparatus 10. If a symmetric key table is not to be transmitted (N of S10), the verification unit 40 will receive, from the processing unit 28, the data and the data format of the message type used to transmit the data. Then, a secure frame in which the received data is stored in the payload is generated (S12). At this time, the key ID and the signature are empty, and therefore “0” is stored in all of these, for instance. Then, if the data format of the message type is plaintext data (Y of S14), the secure frame will be directly broadcast as a packet via the MAC frame processing unit 56, the modem unit 54, the RF unit 52, and the antenna 50. If the data format of the message type is data with signature or encrypted data (N of S14), a symmetric key will be selected (S16). The symmetric key is selected randomly from the latest symmetric key table. As the symmetric key is selected, the table ID of the latest symmetric key table and the selected symmetric key ID are stored in the key ID of the secure frame. If the data type is data with signature after the data format of the message type is referenced again (Y of S18), the verification unit 40 will compute a digital signature for the payload header and the payload by the use of the selected symmetric key, at the encryption unit 42, and store the computed value in the signature of the secure frame (S20). Then, the secure frame with signature is broadcast as a packet via the MAC frame processing unit 56, the modem unit 54, the RF unit 52, and the antenna 50 (S22). If the data format of the message type is encrypted data (N of S18), the verification unit 40 will compute the MAC value of the payload at the encryption unit 42 and then the computed MAC value will be stored in the signature of the secure frame (S24). Then, the payload header and the signature are encrypted by the use of the selected symmetric key (S26). Then, the encrypted secure frame is broadcast as a packet via the MAC frame processing unit 56, the modem unit 54, the RF unit 52, and the antenna 50 (S22).

If a symmetric key table is to be transmitted (Y of S10), the verification unit 40 will acquire a symmetric key table to be broadcast, from the storage unit 44, generate a secure frame (S28) and select a symmetric key (S30). The verification unit 40 computes the MAC value of the payload and store the MAC value thereof in the signature of the secure frame (S24). Then, the payload header and the signature are encrypted by the use of the selected symmetric key (S26). Then, the encrypted secure frame is broadcast as a packet via the MAC frame processing unit 26, the modem unit 24, the RF unit 22, and the antenna 20 (S22).

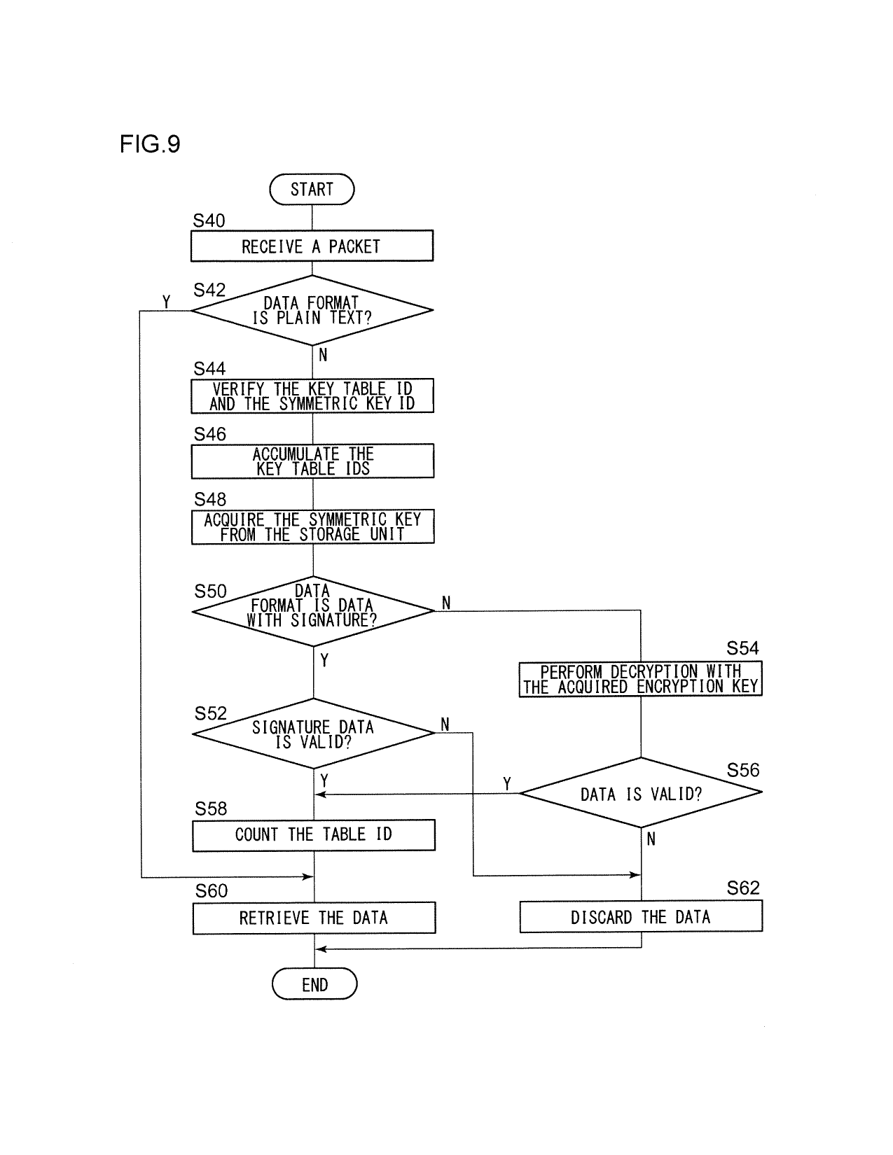

FIG. 9 is a flowchart showing a procedure for receiving packets in the base station apparatus 10. The antenna 20, the RF unit 22 and the modem unit 24 receive a packet (S40). If the data format is data with signature or encrypted data (N of S42), the verification unit 40 will verify the table ID and the symmetric key ID (S44). The storage unit 44 stores up the table IDs (S46). The verification unit 40 acquires a symmetric key from the storage unit 44 (S48). If the data format is data with signature (Y of S50) and if the signature data is valid (Y of S52), the verification unit 40 will count the table ID (S58). If the data format is encrypted data (N of S50), the verification unit 40 will decrypt with the acquired encryption key (S54). If the data is valid (Y of S56), the verification unit 40 will count the table ID (S58). If the data is not valid (N of S56), the verification unit 40 will discard the data (S62). If the signature data is not valid (N of S52) or if the data is not valid (N of S56), the verification unit 40 will discard the data (S62). If the table ID has been counted or if the data format is plain text (Y of S42), the verification unit 40 will retrieve the data (S60).

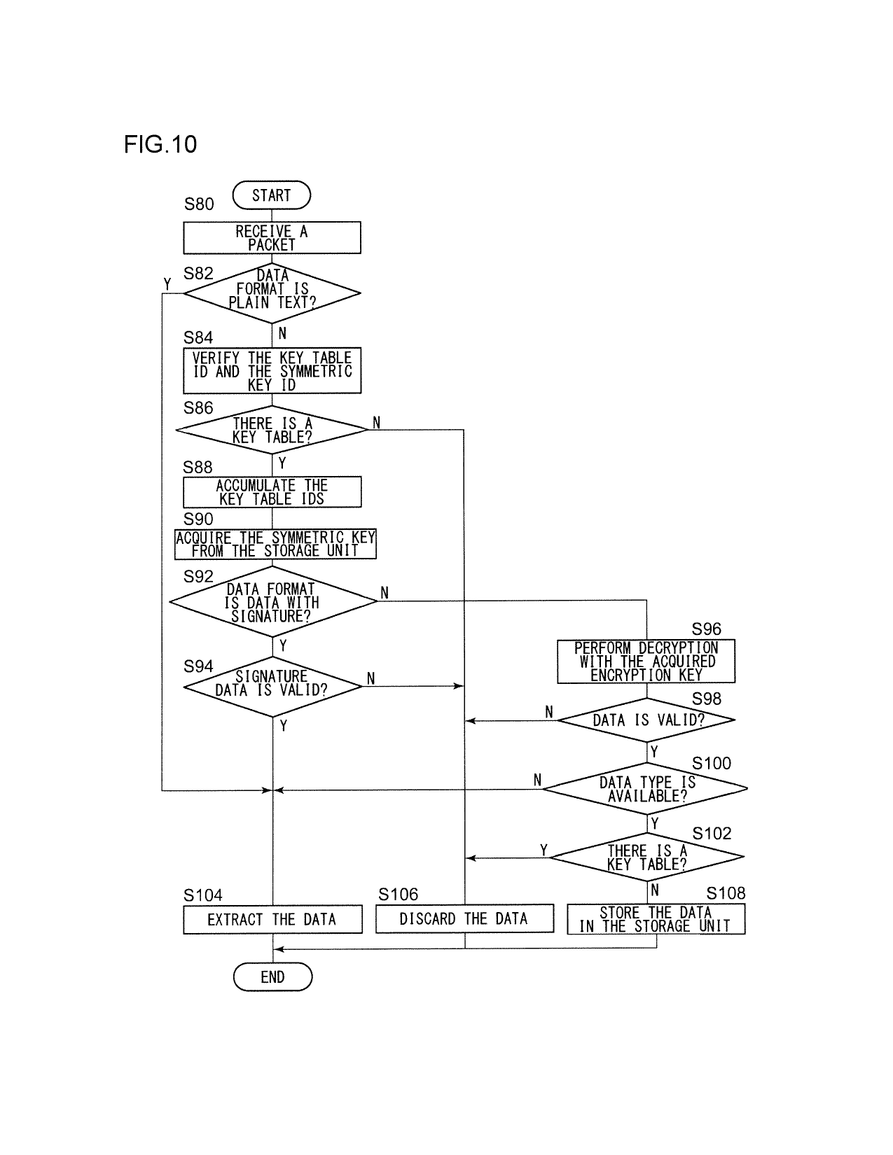

FIG. 10 is a flowchart showing a procedure for receiving packets in the terminal apparatus 14. The antenna 50, the RF unit 52 and the modem unit 54 receive a packet (S80). If the data format is data with signature or encrypted data (N of S82), the verification unit 62 will verify the table ID and the symmetric key ID (S84). If the storage unit 66 has a key table (Y of S86), the storage unit 66 will store up the table IDs (S88) and the verification unit 62 will acquire a symmetric key from the storage unit 66 (S90). If the data format is data with signature (Y of S92) and if the signature data is not valid (N of S94), the verification unit 62 will extract the data (S104).

If, on the other hand, the data format is encrypted data (N of S92), the verification unit 62 will decrypt the data with the acquired encryption key (S96). If the data is valid (Y of S98) and if no data type is available (N of S100), the verification unit 62 will extract the data (S104). If the data format is plain text (Y of S82), the verification unit 62 will retrieve the data (S104). If the storage unit 66 does not have a key table (N of S86) or if the signature data is not valid (N of S94) or if the data is not valid (N of S98), the verification unit 62 will discard the data (S106). If the data type is available (Y of S100) and if there is a key table (Y of S102), the verification unit 62 will discard the data (S106). If there is no key table (N of S102), the verification unit 62 will store the data in the storage unit 66 (S108).

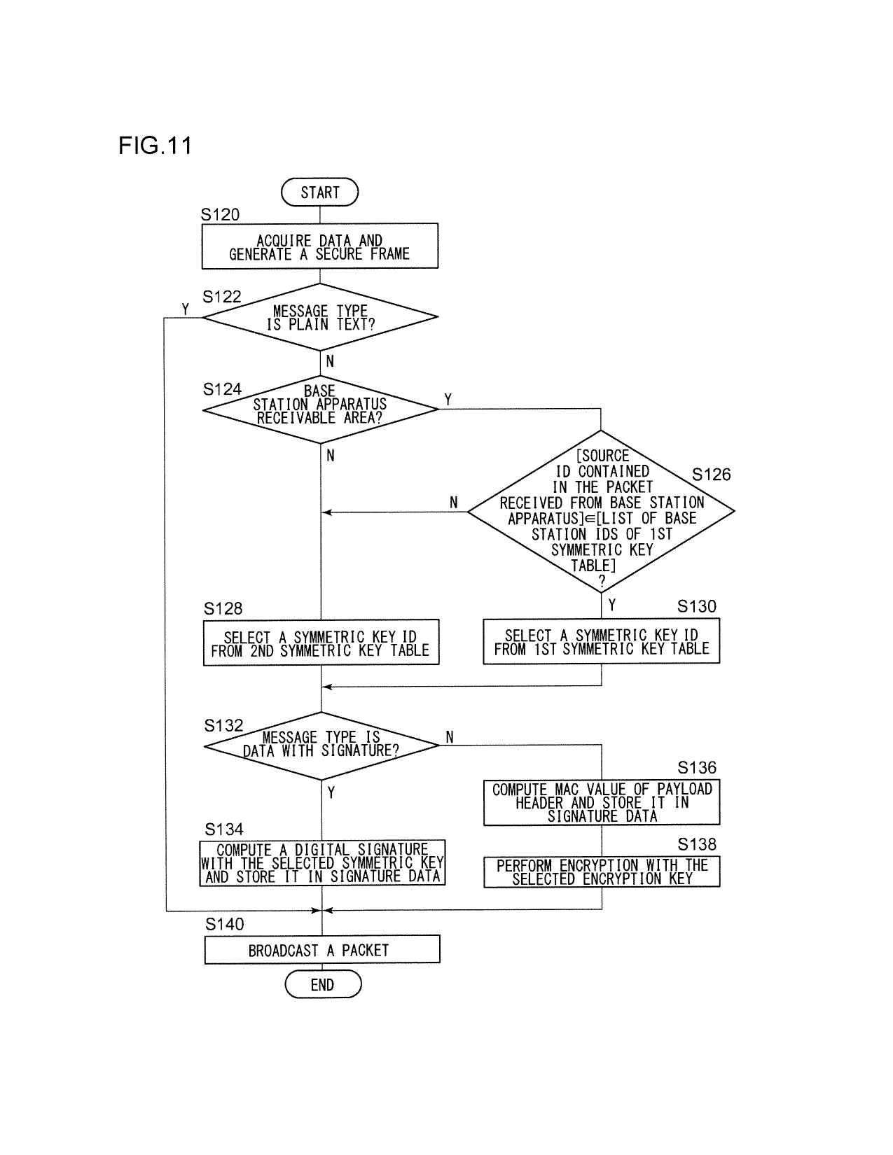

FIG. 11 is a flowchart showing a procedure for transmitting packets in the terminal apparatus 14. The verification unit 62 acquires the data and generates a secure frame (S120). If the message type is data with signature or encrypted data (N of S122) and if the location is not within a base station apparatus receivable area (N of S124), the verification unit 62 will select a symmetric key from the second symmetric key table (S128). If the location is within the base station apparatus receivable area (Y of S124) and even if the source ID contained in the packet received from the base station apparatus 10 is not contained in the list of base station IDs in the first symmetric key table (N of S126), the verification unit 62 will select a symmetric key from the second symmetric key table (S128).

If the source ID contained in the packet received from the base station apparatus 10 is contained in the list of base station IDs (Y of S126), the verification unit 62 will select a symmetric key from the first symmetric key table (S130). If the message type is data with signature (Y of S132), the verification unit 62 will compute a digital signature by the use of the selected symmetric key and store the computed value in the signature data (S134) and broadcast the packet via the modem unit 54, the RF unit 52, and the antenna 50 (S140). If the message type is encrypted data (N of S132), the verification unit 62 will compute a MAC value of the payload header and store the computed MAC value thereof in the signature data (S136). The verification unit 62 performs encryption with the selected encryption key (S138), and the modem unit 54, the RF unit 52 and the antenna 50 broadcast the packet (S140). If the message type is plain text (Y of S122), the modem unit 54, the RF unit 52 and the antenna 50 will broadcast the packet (S140).

By employing the present exemplary embodiment of the present invention, if the location is within a predetermined area, the first symmetric key table, which is different from the second symmetric key table, will be used. Thus, at least two kinds of symmetric key tables can be used according to the area. Also, since at least two kinds of symmetric key tables are used according to the area, only one of the two kinds of symmetric key tables can be updated. Also, since only one of the two kinds of symmetric key tables is updated, an encryption key can be efficiently distributed according to the area. Also, since only one of the two kinds of symmetric key tables is updated, a symmetric key table can be updated in a high-risk area only. Also, if the first symmetric key table is not stored in an predetermined area, a digital signature generated with a symmetric key contained in the first symmetric key table will not be determined to be valid and therefore the security can be ensured.

If the digital signature generated by a symmetric key contained in the first symmetric key table is detected a predetermined number of times or more even though the first symmetric key table is not stored in the predetermined area, the verification will be skipped. Thus, data to which this digital signature has been attached can be acquired. Also, since the data is acquired only when the digital signature is detected a predetermined number of times or more, the risk can be reduced even without the digital signature. Also, since the data is acquired, the approach of other vehicles can be recognized. Also, since a base station apparatus, which does not use the first symmetric key table, also distributes the first symmetric key table, the first symmetric key table can be made more accessible and available to use. Also, since the base station apparatuses that distribute the first symmetric key table are restricted, the degradation of transmitting efficiency can be suppressed.

Also, since a symmetric key is used to generate a digital signature, the processing amount can be reduced as compared with the case where a public key is used. Also, since the processing amount is reduced, the number of processable packets can be increased. Also, since a symmetric key is used to generate a digital signature, the transmitting efficiency can be improved as compared with the case where a public key is used. Also, data such as positional information is not encrypted and therefore the processing amount can be reduced. On the other hand, the symmetric key table is encrypted, so that the security can be improved.

A description is now given of modifications to the exemplary embodiments. To improve the security, it is desirable that encryption keys be updated on a regular basis. In order to update the encryption keys while a symmetric key shared by a plurality of terminal apparatuses is being used, an apparatus for managing the encryption keys needs to be connected within the communication system. However, assume a situation where terminal apparatuses are mainly mounted on vehicles and these vehicles are moving, then there may be areas where the encryption keys cannot be managed by this apparatus for managing the encryption keys. Accordingly, it is desirable that the encryption keys be autonomously updated even under a situation where the terminal apparatuses only are present. A purpose of a modification is to provide a technology by which the encryption keys are autonomously updated.

In this modification, each symmetric key is managed through and as each symmetric key ID, and a plurality of symmetric keys are put altogether in a symmetric key table. Further, the version of a symmetric key table is managed through and as a table ID. Accordingly, each table ID contains a plurality of symmetric key IDs. It is desirable that such a symmetric key table be updated on a regular basis. In times when this type of communication systems were not widely available or in areas where the traffic volume is low, the number of base station apparatuses installed is probably small. If, in such situations, terminal apparatuses are to update the symmetric key table after a new symmetric key table is conveyed from the base station apparatus, the number of terminal apparatuses that have not yet updated the symmetric key table may increase. In order to cope with this, a terminal apparatus according to this modification stores beforehand an irreversible transform function that is used to update the symmetric key table, and generates a new symmetric key table by updating the existing symmetric key table by the use of the irreversible transform function. In other words, the terminal apparatus autonomously updates the symmetric key table on a regular basis.

A communication system 100 according to this modification is of a similar type to that of FIG. 1. A digital signature complying with a public key encryption scheme is effective as the digital signature. More specifically, RSA, DSA, ECDSA and the like are used as methods based on the public key encryption scheme. The digital signature scheme (digital signature scheme) is comprised of key generation algorithm, a signing algorithm, and a signature verifying algorithm. The key generation algorithm corresponds to an advance preparation of a digital signature. The key generation algorithm outputs a public key and a secret key (private key) of the user. A different random number is selected every time the key generation algorithm is executed and therefore a pair of a public key and a secret key is assigned to each user. Each user keeps the secret key, whereas the public key is open to the public. The symmetric key table is managed through the table ID, and the symmetric key table is adapted to the version update by increasing the table IDs. The version upgrade of the symmetric key table is done by both the base station apparatus 10 and the terminal apparatus 14.

A terminal apparatus 14 stores beforehand an irreversible transform function, and generates a new symmetric key table by converting the existing symmetric key table through the irreversible transform function. Thus, the version upgrade of the symmetric key table in the terminal apparatus 14 is autonomously done. Here, the timing with which the version is upgraded may be, for instance, when a predetermined period of time elapses after the use of the present symmetric key table has started. Also, the version upgrade timing may be when the terminal apparatus 14, which receives packets from the other terminal apparatuses 14, detects that the version of a symmetric key table containing a symmetric key used in said packets is new. On the other hand, similarly to the terminal apparatus 14, the base station apparatus 10 may upgrade the version of the symmetric key table and may upgrade the version thereof by receiving a new symmetric key table from the network 202.

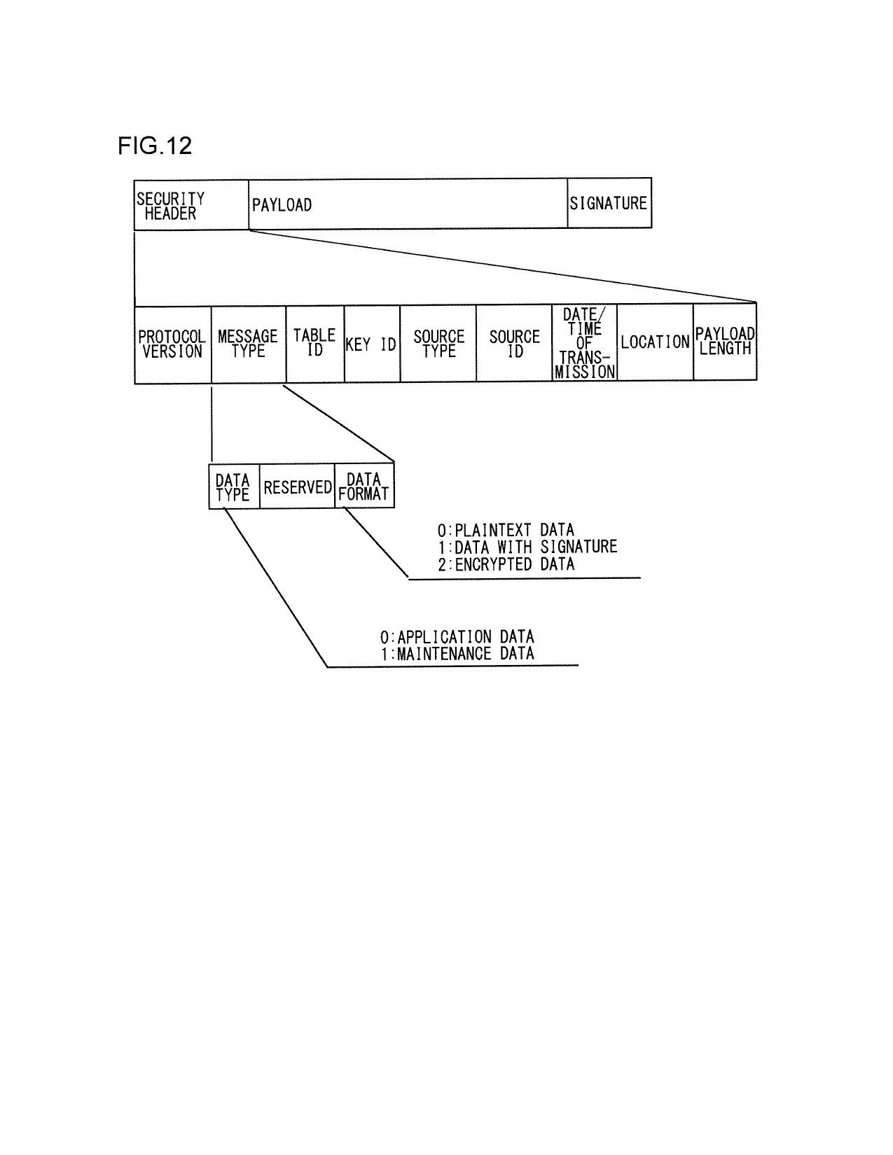

A base station apparatus 10 according to this modification is of a similar type to that of FIG. 2. FIG. 12 shows a format of security frame defined in the communication system 100. The security frame is constituted by “security header”, “payload”, and “signature”. The security header is constituted by “protocol version”, “message type”, “table ID”, “key ID”, “source type”, “source ID”, “date/time of transmission”, “location”, and “payload length”. Protocol version is identification information by which to specify the format of a security frame. The protocol version is a fixed value in the communication system 100. The message type includes “data type”, “data format”, and “reserve”. The data type sets the flag information defined as follows. The flag information identifies whether the data stored in the payload is application data (=0), namely data outputted to the subsequent MAC frame processing unit 26, or maintenance data (=1), namely security information processed within the verification unit 40.

The data format is a format concerning the security of data stored in the payload, namely a flag that defines a process for encrypting the payload. Here, it is assumed that plaintext data (=0), data with signature (=1), and encrypted data (=2) are set. Note that “reserve” is a reserve for future use and will not be used by the communication system 100. A table ID is identification information used to identify a symmetric key table that contains a symmetric key used for the encryption of the digital signature or payload. A key ID is identification information by which a symmetric key used for the encryption of the digital signature or payload is identified, and corresponds to the aforementioned symmetric key ID. A source type ID sets the type of a sender of packets. That is, the source type ID is set to identify a base station apparatus 10 (=3), a terminal apparatus (=2) mounted on an emergency vehicle (hereinafter referred to as “priority vehicle” also) such as a fire-extinguishing vehicle and an ambulance vehicle, a terminal apparatus (=1) mounted on other vehicles (hereinafter referred to as “ordinary vehicles” also), and a terminal apparatus (=0) mounted on a non-vehicle. The source ID is unique identification information by which a base station apparatus 10 or a terminal apparatus 14 that has transmitted the packet can be uniquely identified.

The payload is a field that stores the aforementioned data, and corresponds to intersection information, road information and the like to be conveyed to the terminal apparatus. If the data format of the message type is data with signature (=1), a digital signature for the security header and the payload will be generated. When the data format of the message type is encrypted data (=2), this data may be regarded as invalid. However, it is assumed herein that stored are a fixed value, a value identifiable at a receiving side, such as a copy of a security header portion, or a hash value (a computational result for a hash function) for a security header and/or a payload before encryption, and a computable value at a receiving side, such as checksum and parity. Then the payload is encrypted. By so doing, if the value stored in the decrypted signature agrees with a value identified at the receiving side or a computed value, the decryption will be done normally and therefore the validity of data stored in the payload or data stored in the payload and payload header can be verified. Each feed length is as follows, for instance. That is, the security header is of 32 bytes, the payload is of 100 bytes (if broadcast from a terminal apparatus) or of 1K bytes (if broadcast from a base station apparatus), and the signature is of 16 bytes, for instance.

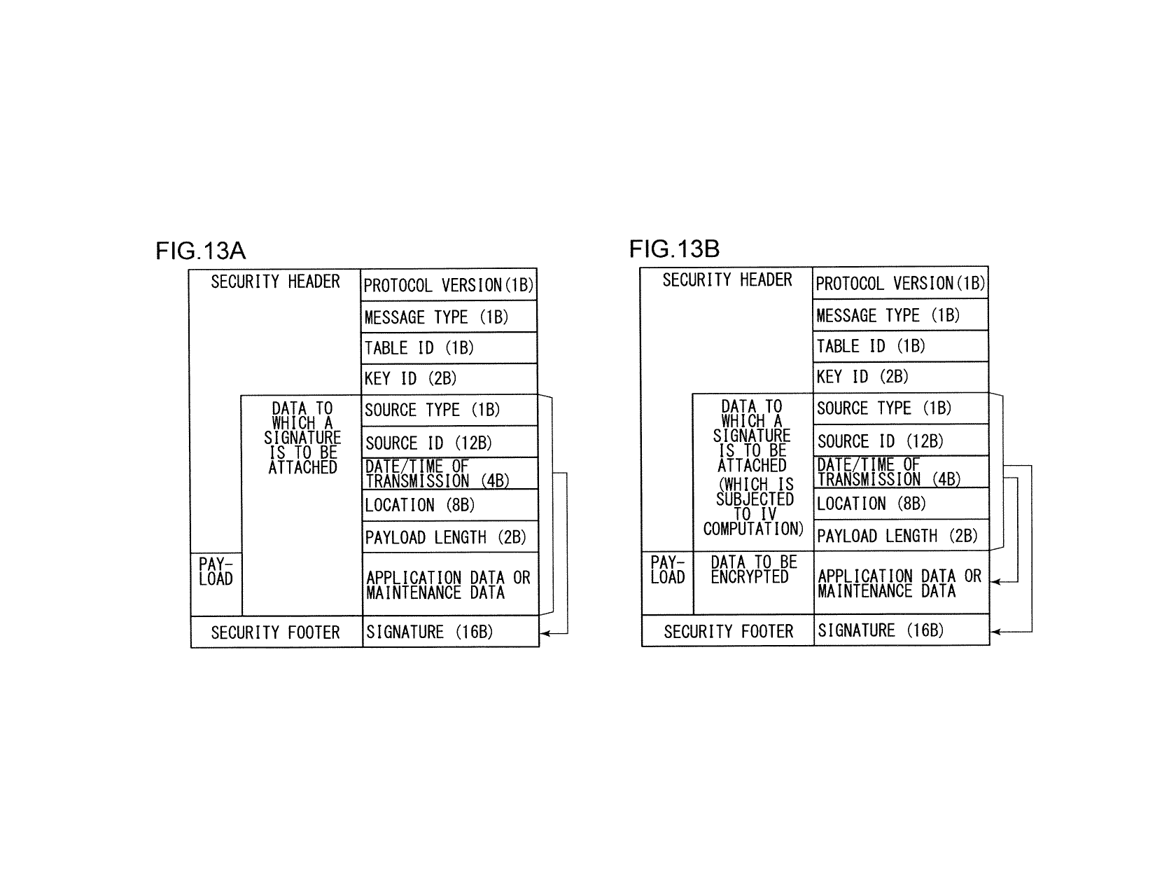

In the communication system 100, AES (Advanced Encryption Standard) encryption is used as the encryption scheme. FIGS. 13A and 13B show processing contents for the secure frame. FIG. 13A shows a case where the data format of the message type is data with signature. A digital signature is computed for a part of security header, which is namely comprised herein of source type, source ID, date/time of transmission, location, payload length, and payload. The thus computed value is stored in a signature of a security footer. The reason for the inclusion of the source type and the source ID in the digital signature to be computed is to prove the features of an in-vehicle unit or roadside unit of a source (sender of signals). Also, the reason for the inclusion of the date/time of transmission and location is to prevent the falsification of location and prevent the interference caused by the interception of packets and the retransmission of the packets. FIG. 13B shows a case where the data format of the message type is encrypted data. A digital signature is computed for a part of security header, which is namely comprised herein of source type, source ID, date/time of transmission, location, and payload length. The thus computed value is stored in a signature of a security footer. The payload is encrypted in a CBC (Cipher Block Chaining) mode. When a first block is encrypted in the CBC mode, an initial vector (hereinafter referred to as “IV”) is used. Normally, any value may be used for the initial value. However, in the communication system 100, the data stored in the payload is encrypted by binding (associating) the data to the sender of the information, thereby improving the reliability of the data. Here, the computation is done based on the source type, source ID, date/time of transmission, location, and payload so as to determine the IV. More specifically, the previously-obtained value of the digital signature for the security header is used as IV. Now refer back to FIG. 2.

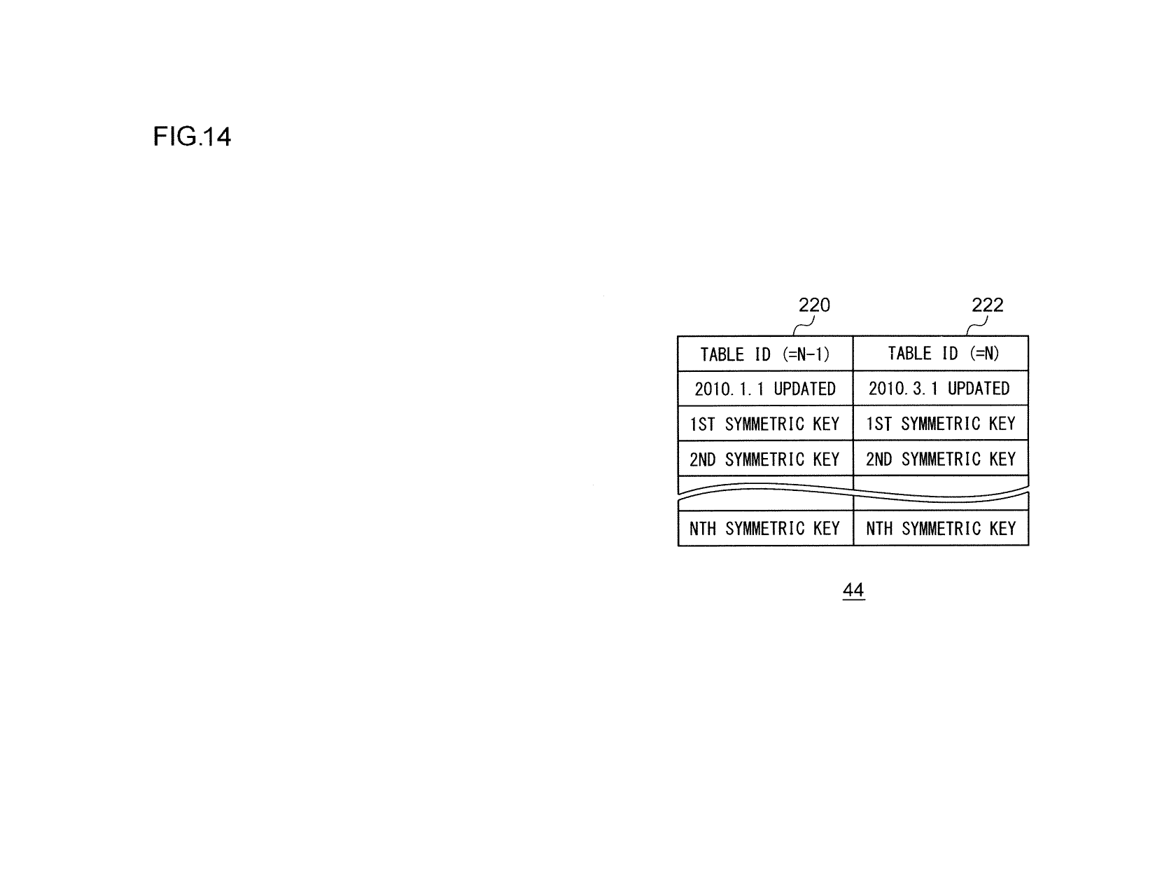

The storage unit 44 stores a plurality of symmetric key tables each containing a symmetric key usable in the communication system 100. FIG. 14 shows a data structure of a symmetric key table stored in the storage unit 44. A plurality of different versions may be available for the symmetric key table. In such a case, they are managed through the table IDs. In FIG. 14, a first table 220 corresponds to a case where its table ID is “N−1”, and a second table 222 corresponds to a case where its table ID is “N”. The version of the second table 222 is newer that that of the first table 220. Though two symmetric key tables are shown here, three or more symmetric key tables may be stored in the storage unit 44. Each symmetric key table contains a plurality of symmetric keys, and each of the symmetric keys is managed through the symmetric key ID. In FIG. 14, a first symmetric key corresponds to a case where its symmetric key ID is “1”, and a second symmetric key corresponds to a case where its symmetric key ID is “2”. Thus, a symmetric key is identified through the combination of a table ID and a symmetric key ID. Each symmetric key table includes information regarding update date/time. The update date/time of the first table 220 is “2010.1.1” (Jan. 1, 2010) and that of the second table 222 is “2010.3.1” (Mar. 1, 2010). In order to make up for a period until when the updating of symmetric key tables is conveyed to and effected by the base station apparatuses and the terminal apparatuses, the storage unit 44 stores at least one symmetric key table in the past. Now refer back to FIG. 2.

When generating the security frame, the verification unit 40 extracts a symmetric key by referencing the storage unit 44. For example, an update date/time is specified in each symmetric key table, and the verification unit 40 generates a symmetric key table based on the present time. The verification unit 40 selects, from among the symmetric key tables in use, a most current symmetric key table whose update date/time is the latest. Further, the verification unit 40 selects a symmetric key from within the selected symmetric key table. This selection may be made at random or according to the identification numbers assigned to the base station apparatuses 10.

If the data format of the message type is data with signature, the encryption unit 42 of the verification unit 40 will compute a digital signature for the security header and the payload by the use of the selected symmetric key. If the data format of the message type is encrypted data, the payload will be encrypted by the encryption unit 42. If the data format of the message type is plaintext data, the verification unit 40 will output the generated security frame to the MAC frame processing unit 26 as it is. If the security frame is to be generated by the use of the data received from the MAC frame processing unit 26, the verification unit 40 will set the data type of the message type to the application data (=0).

When reading the security frame, the verification unit 40 acquires the table ID of the security frame received from the MAC frame processing unit 26 and the symmetric key ID. Then, the verification unit 40 references the storage unit 44 and extracts a symmetric key identified by the table ID and the symmetric key ID. Further, if the data format of the message type of the security frame received from the MAC frame processing unit 26 is data with signature, the verification unit 40 will use the extracted symmetric key and verify the validity of the signature. More precisely, the encryption unit 42 computes the digital signature for the security header and the payload, and the computed value is compared against the value of the digital signature stored in the signature of the security frame received from the MAC frame processing unit 26. If the two values of the digital signatures agree with each other, it will be determined that the digital signature is valid and that the information contained in the security frame is information sent from a proper base station apparatus 10 or terminal apparatus 14, and the information will be outputted to the MAC frame processing unit 26. If the two values of the digital signatures do not agree with each other, it will be determined that the digital signature is not valid, and therefore the data will be discarded.

Also, if the data format of the message type is encrypted data, the encryption unit 42 will decrypt the payload and the signature. Then, if the signature has a predetermined value, it will be determined that the data extracted from the security frame has been normally decrypted, and the data extracted from the security frame will be outputted to the MAC frame processing unit 26. If, however, the signature does not have the predetermined value, the data will be discarded. If the data format of the message type is plaintext data, the verification unit 40 will output the data extracted from the received security frame, to the MAC frame processing unit 26 without any preconditions.

The processing unit 28 processes the data received from the verification unit 40. The processing result may be directly outputted to the not-shown network via the network communication unit 32 or may be accumulated internally and then outputted to the not-shown network at regular intervals. Also, the processing unit 28 receives the road information (e.g., road repairing, congestion situation) from the not-shown network via the network communication unit 32, and/or receives the information on the intersections gained from the not-shown sensors via the sensor communication unit 34. The processing unit 28 generates data to be sent to the terminal apparatus 14, based on these pieces of information. Also, upon receipt of a new symmetric key table from a not-shown server apparatus via the network communication unit 32, the processing unit 28 writes the new symmetric key to the storage unit 44 of the verification unit 40. The control unit 30 controls the entire processing of the base station apparatus 10.

These structural components may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

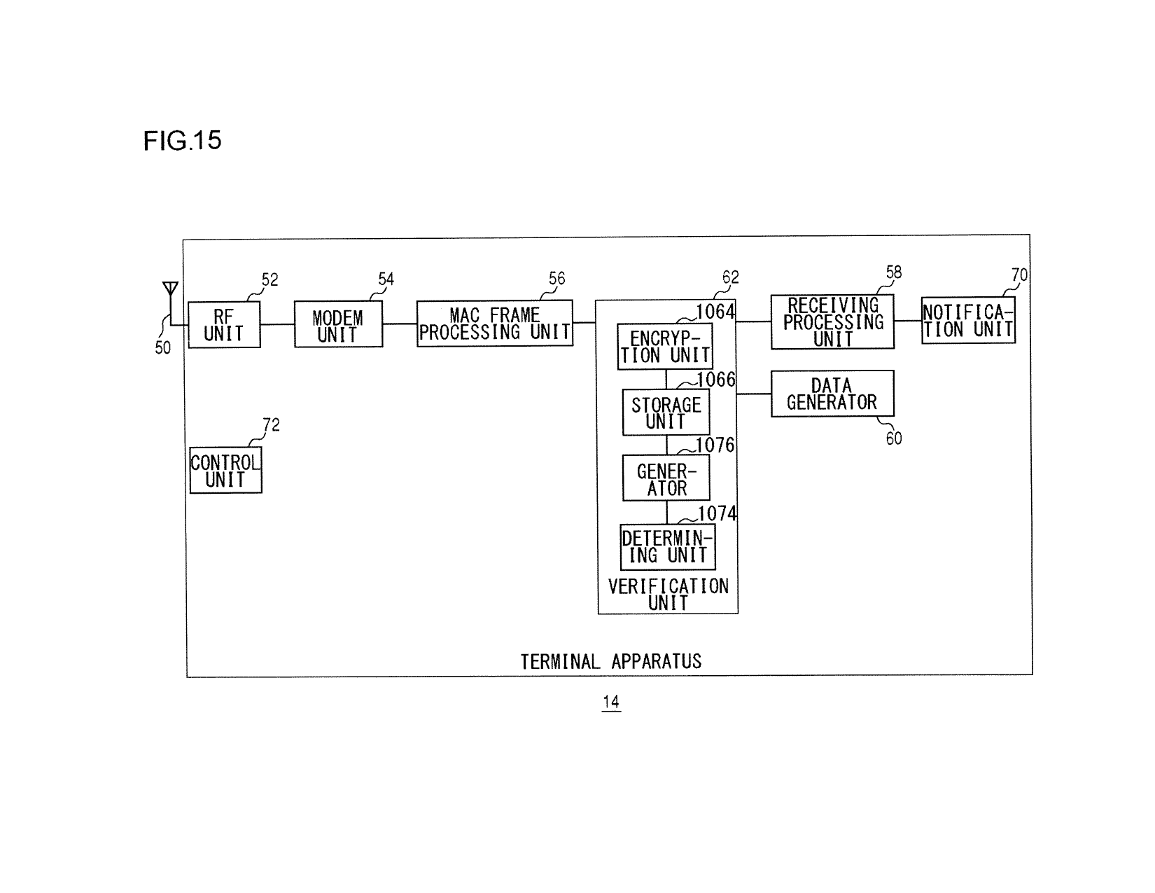

FIG. 15 shows a structure of a terminal apparatus 14 mounted on a vehicle 12. The terminal apparatus 14 includes an antenna 50, an RF unit 52, a modem unit 54, a MAC frame processing unit 56, a receiving processing unit 58, a data generator 60, a verification unit 62, a notification unit 70, and a control unit 72. The verification unit 62 includes an encryption unit 1064, a storage unit 1066, a generator 1076, and a determining unit 1074. The antenna 50, the RF unit 52, the modem unit 54, the MAC frame processing unit 56, the verification unit 62, the encryption unit 1064, and the storage unit 1066 perform the processings similar to those of the antenna 20, the RF unit 22, the modem unit 24, the MAC frame processing unit 26, the verification unit 40, the encryption unit 42, and the storage unit 44 of FIG. 2, respectively. Thus, the description of the similar processings thereto is omitted here and a description is given centering around features different from those of FIG. 2.

Similar to the verification unit 40, the verification unit 62 generates and reads (interprets) a security frame. That is, the storage unit 1066 stores a symmetric key table that indicates a plurality of kinds of symmetric keys usable for the transmitting and the receiving of the packet in the RF unit 52 and the like; similar to the verification unit 40, the verification unit 62 selects any one of symmetric keys from within the symmetric key table stored in the storage unit 1066. Also, the verification unit 62 verifies the digital signature attached to the packet received by the RF unit 52 and the like, by the use of the selected symmetric key or generates a digital signature attached to a packet that is to be transmitted from the RF unit 52 and the like. Note that the verification unit 62 may use a symmetric key for the encryption and decryption.

The determining unit 1074 determines the timing with which the symmetric key table stored in the storage unit 1066 is to be updated. The determining unit 1074 stores in advance the information on dates/times at which the symmetric key table is to be updated. When a date/time acquired by a not-shown clock provided in the determining unit 1074 reaches a preset date/time, the determining unit 1074 instructs the generator 1076 to update the symmetric key table. Here, the date/time at which the common table is to be updated is determined at regular intervals, with the result that the symmetric key table is updated at regular intervals. To prevent too large a difference from the other terminal apparatuses regarding the date/time, the internal clock is adjusted with the date/time information acquired by the GPS receiver or the date/time information contained in the packet received from the MAC frame processing unit. Though a description has been given here of a configuration where the determining unit 1074 is provided with the clock, the clock does not need to be provided inside the terminal apparatus 14. The determination may be made by acquiring the date/time information obtained by the GPS receiver included in the data generator 60.

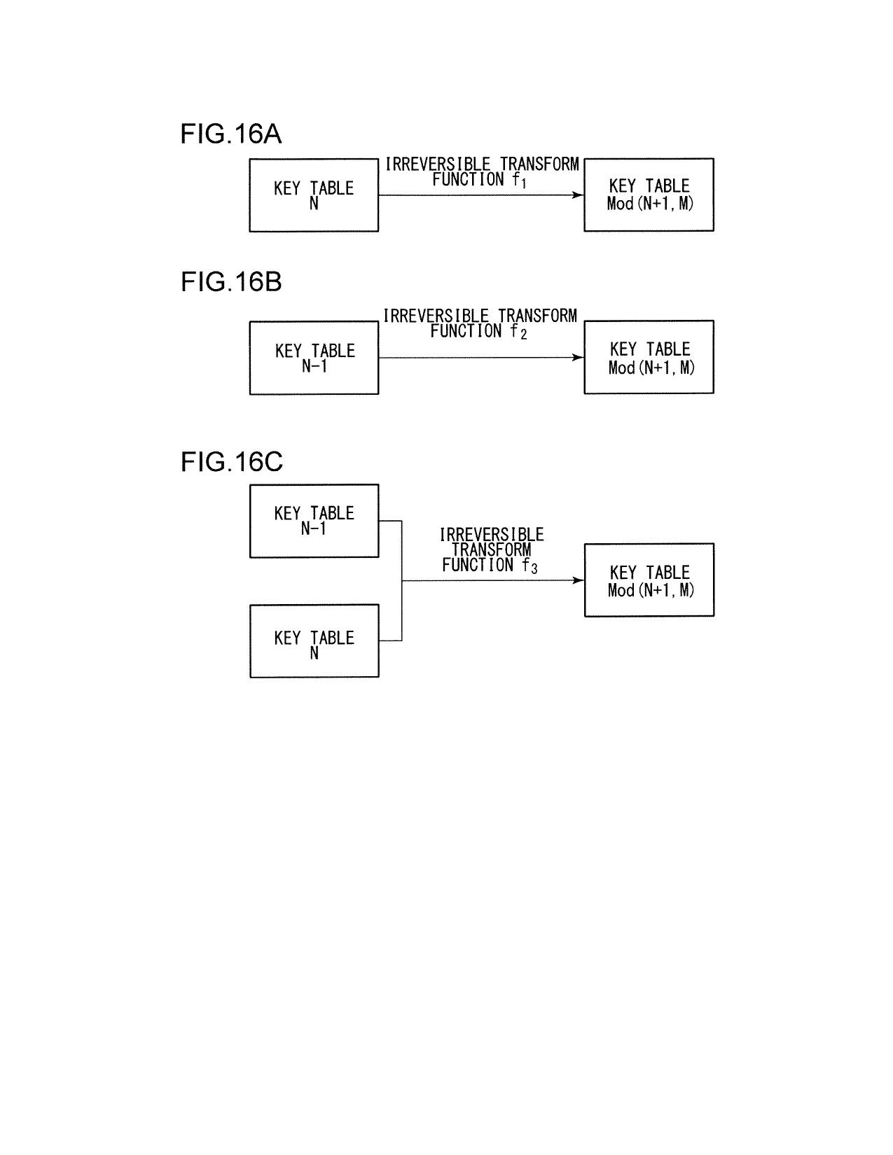

As an instruction to update a table is received from the determining unit 1074, the generator 1076 subjects a symmetric key table stored in the storage unit 1066 to an operation by an irreversible transform function and thereby updates the symmetric key table. Updating the symmetric key table means updating a plurality of respective symmetric keys contained in the symmetric key table. The irreversible transform function is predetermined. FIGS. 16A to 16C show brief overviews of the updating of a symmetric key table by the generator 1076. Suppose that the maximum number that can be managed through the table IDs is M (M being a natural number), then a table ID is a value in a residue system modulo M, and “N−1”, “N”, and “N+1” are remainder values modulo M. FIG. 16A shows that a new symmetric key table is generated when an irreversible transform function f1 is used for the latest symmetric key table stored in the storage unit 1066, namely a symmetric key table whose table ID is N. The table ID of the new symmetric key table is N+1.

FIG. 16B shows that a new symmetric key table is generated when an irreversible transform function f2 is used for a symmetric key table in the past stored in the storage unit 1066, namely a symmetric key table whose table ID is N−1. FIG. 16C shows that a new symmetric key table is generated when an irreversible transform function f3 is used for both the latest symmetric key table stored in the storage unit 1066, namely a symmetric key table whose table ID is N, and a symmetric key table in the past stored in the storage unit 1066, namely a symmetric key table whose table ID is N−1. In this case of FIG. 16C, one symmetric key table is generated with two symmetric key tables. The new symmetric key table is recorded in the storage unit 1066. At this time, the new symmetric key table may be recorded in a new region of the storage unit 1066 or may be recorded by overwriting the oldest symmetric key table. If the storage unit 1066 is of such a structure that only two symmetric key tables can be recorded as in the case of FIG. 14, the oldest symmetric key table (Table ID=N+1) will be replaced by a new symmetric key table (Table ID=N+1). Though a description has been given of a concept for updating a symmetric key table on the assumption that two symmetric key tables are being recorded, this does not limit a previous symmetric key table from which a new symmetric key table is to be generated. A configuration can be implemented where a new symmetric key table is generated from one or a plurality of symmetric key before updating. In such a case, the storage unit 1066 must store the symmetric key table(s) from which the new symmetric key table is generated. Now refer back to FIG. 15

The determining unit 1074 may acquire the timing with which the symmetric key table is to be updated, based on the table ID contained in the packet received from the MAC frame processing unit 56. More specifically, if the data format of the message type data is data with signature or encrypted data and if the symmetric key table containing the table IDs is not stored in the storage unit 1066, the verification unit 62 will generate a symmetric key, corresponding to the table ID and the symmetric key ID contained in the packet, at the generator 1076. Then, if the data format of the message type data is data with signature, the encryption unit 1064 of the verification unit 62 will compute a digital signature for the security header and the payload by the use of the selected symmetric key generated by the generator 1076. Also, if the data format of the message type is encrypted data, the encryption unit 42 of the verification unit 62 will compute a digital signature for the security header by the use of the symmetric key generated by the generator 1076 and then decrypt the payload. If these processes have been carried out normally, the determining unit 1074 will determine that the generated symmetric key is valid. If the symmetric key generated is valid, the determining unit 1074 will instruct the generator 1076 to update the previous symmetric key table containing the table IDs. The control unit 72 controls the entire operation of the terminal apparatus 14.

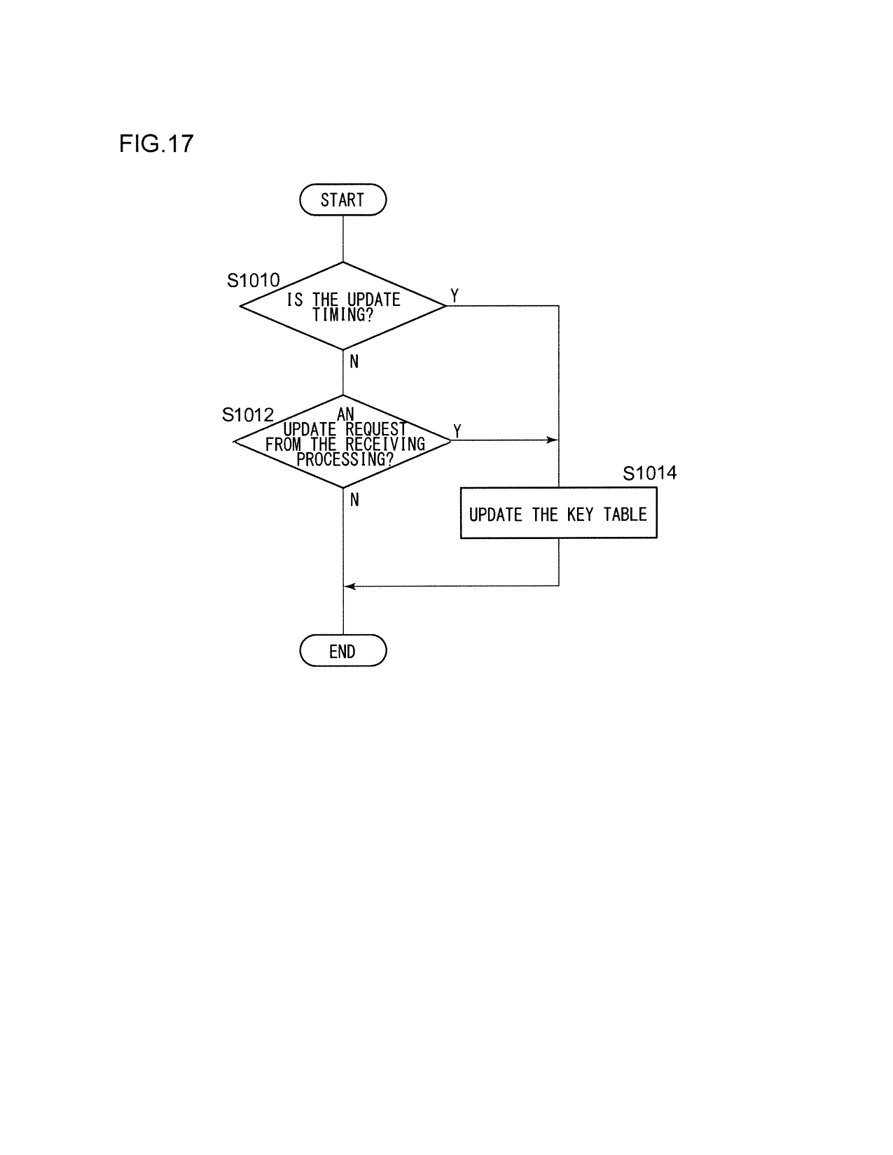

An operation regarding the transmitting/receiving of packets in the communication system 100 configured as above is now described. FIG. 17 is a flowchart showing a maintenance procedure for a symmetric key table in the terminal apparatus 14. The determining unit 1074 determines if the update schedule date/time derived from the present time, the table ID of the latest symmetric key table stored in the storage unit 1066, and the last updated date/time is the update timing (S1010). If the determining unit 1074 determines the update schedule date/time to be the update timing (Y of S1010), the generator 1076 will update the symmetric key table (S1014). If the determining unit 1074 determines it not to be the update timing (N of S1010), the determining unit 1074 will check an update request sent from the receiving processing (S1012). This means that whether the symmetric key table is to be updated or not is determined based on the table ID contained in the packet received from the MAC frame processing unit 56. If the update request is received through the table ID contained in the table ID, it will be determined to be the update timing (Y of S1012). That is, if the data signed or encrypted by the use of a symmetric key contained in the table specified by the table ID which is not stored in the packet is detected, the generator 1076 will update the symmetric key table (S1014). If the update request is not received from the receiving processing, the determining unit 1074 will determined it not to be the update timing (N of S1012). The process is finished.

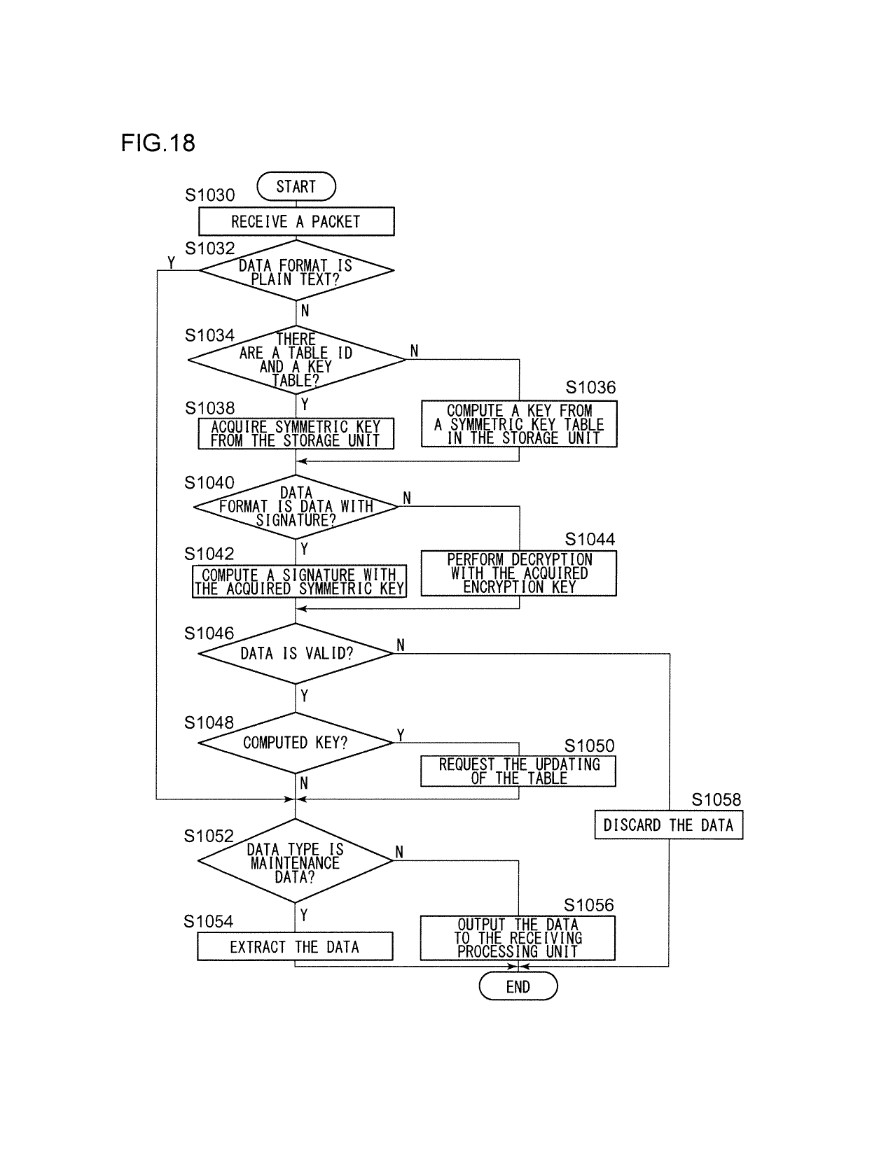

FIG. 18 is a flowchart showing a procedure for receiving packets in the terminal apparatus 14. The antenna 50, the RF unit 52, and the modem unit 54 receive the packet (S1030). If the data format is data with signature or encrypted text (N of S1032), the verification unit 62 will check to see if the table ID and the symmetric key ID are stored in the storage unit 1066 (S1034). If the storage unit 1066 has a key table (Y of S1034), the verification unit 62 will acquired a symmetric key from the storage unit 1066 (S1038). If the storage unit 1066 does not have a key table (N of S1034), the generator 1076 will compute a key from the symmetric key table in the storage unit 1066 (S1036).

If the data format is data with signature (Y of S1040), the verification unit 62 will compute a digital signature for a part of the security header and the payload by the use of the acquired symmetric key (S1042). If, on the other hand, the data format is encrypted text (N of S1040), the verification unit 62 will decrypt the encrypted text with the acquired symmetric key (S1044). The decryption of data includes the computation of a digital signature for a part of the security header and the decryption of a payload that has been encrypted with the computed value of the digital signature as IV. The computed value of the digital signature and the value of the signature in a security footer are compared with each other. If these values agree with each other, it will be determined that the data is valid (Y of S1046). If the data is valid and is a computed symmetric key (Y of S1048), the request for the updating of the symmetric key table is made to the determining unit 1074 (S1050). If the data is not a computed symmetric key (N of S1048), Step S1050 will be skipped.

If the data format is plain text (Y of S1032), Step S1034 to Step S1050 will be skipped. If the data type is maintenance data (Y of S1052), the verification unit 40 will extract the data (S1054). If the data type is application data (N of S1052), the verification unit 40 will output the data to the receiving processing unit 58 (S1056). If the data is not valid (N of S1046), the verification unit 40 will discard the data (S1058).

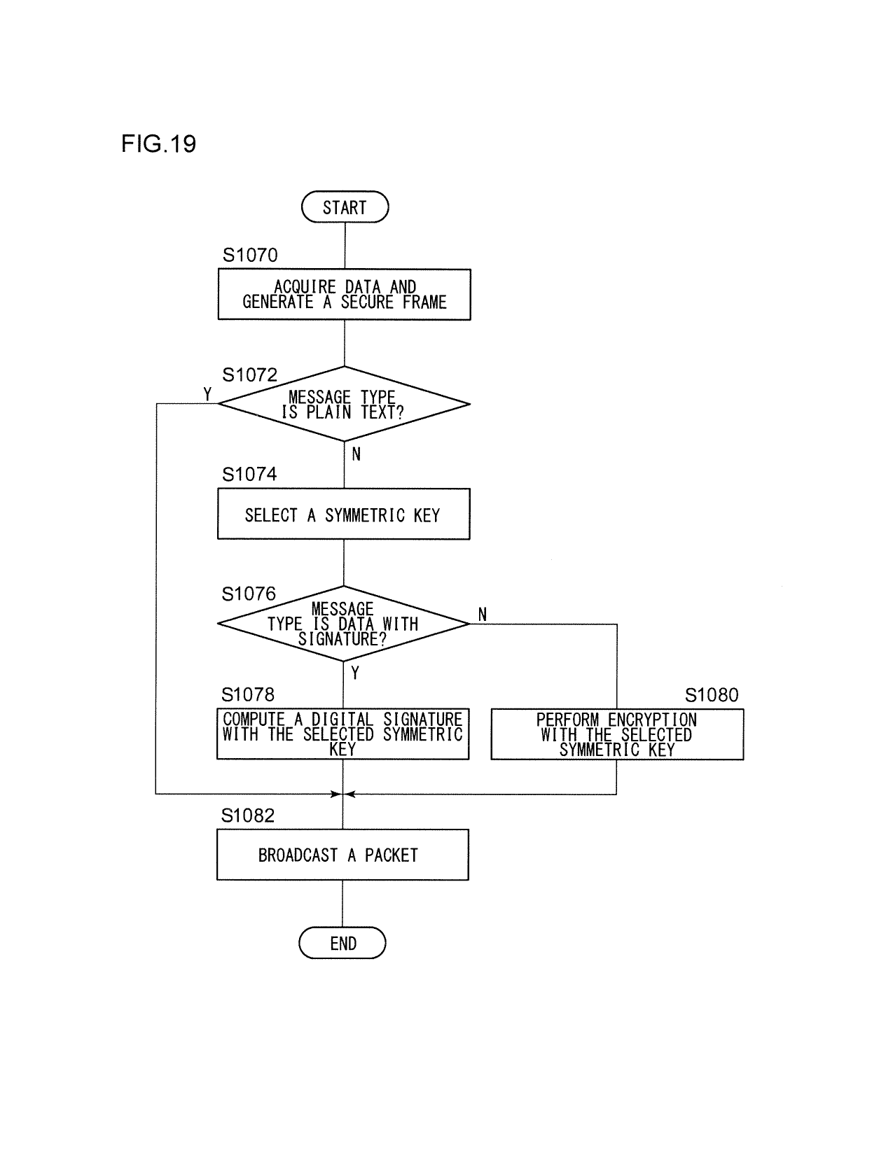

FIG. 19 is a flowchart showing a procedure for transmitting packets in the terminal apparatus 14. The verification unit 62 acquires the data and generates a secure frame (S1070). If the message type is data with signature or encrypted text (N of S1072), the verification unit 62 will select a symmetric key (S1074). If the message type is data with signature (Y of S1076), the verification unit 62 will compute a digital signature with the selected symmetric key (S1078). If the message type is encrypted text (N of S1076), the verification unit 62 will perform encryption with the selected symmetric key (S1080). If the message type is plain text (Y of S1072), the processes of Step S1074 to Step S1080 will be skipped. The modem unit 54, the RF unit 52, and the antenna 50 broadcast the packet (S1082).

In the above-described modifications, a description has been given of a case where both the determination through a reserved date/time and the determination based on the table ID contained in the received packet are used, in parallel with each other, in determining the update timing of the symmetric key table. However, the update timing may be determined using one of these two determinations. If only the former is used, all terminal apparatuses 14 must have means for acquiring the date/time information from clocks, GPS or the like. If the latter is used, the latest symmetric key table stored in the base station 10 or in the storage unit 1066 of a terminal apparatus mounted on a vehicle 12 recently introduced to the market may trigger the updating of the symmetric key table and thereby the updated symmetric key will prevail in all of the terminal apparatuses 14. Though a description has been given regarding a terminal apparatus 14, it may be applied to the base station apparatus 10 as well. In such a case, it will be particularly useful for a base station that is not equipped with the network communication unit 32 of FIG. 2.

In the above-described modifications, a description has been given of a case where a symmetric key table is selected regardless of the source type. However, a symmetric key table for each source type may be stored in the storage unit 1066 and then a symmetric key table best suited to its source type may be selected when the packet is broadcast. At the time when the packet is received, a symmetric key table is selected through the source type and the table ID. The update timing of the symmetric key tables may be independently different or simultaneous. If the update timing of the symmetric key tables is identical to each other, the irreversible transform function by which the symmetric key tables are updated may use the symmetric key tables as parameters for each other. Instead of having a symmetric key table for each source, the same advantageous effects can be achieved when a symmetric key for signature or encryption is computed from a symmetric key contained in the symmetric key table stored in the storage unit 1066 and the source type. In such cases, the symmetric key used for signature or encryption is already bound to (associated with) the source type and therefore the source type may be removed from the computational list of the digital signature. By employing this modification, the total number of keys in simultaneous use increases and the number of sample data required for the decryption of a symmetric key is reduced. In particular, the number of sample data for the priority vehicles such as an ambulance vehicle and a fire-extinguishing vehicle drops sharply, and the leakage risk of symmetric keys in a communication channel is reduced.

In the above-described modifications, the generator 1076 stores beforehand the irreversible transform function. However, this should not be considered as limiting and, for example, the irreversible transform function may be supplied from the base station apparatus 10. In such a case, the packet containing the irreversible transform function will be encrypted. By employing this modification, the irreversible transform function can be varied.

According to the above-described modifications, the terminal apparatus autonomously updates the symmetric key table, so that the security can be enhanced even though the base station apparatus does not distribute the symmetric key table. Also, since the irreversible transform function is operated on the already-stored symmetric key table, the symmetric key table can be autonomously updated even though the base station apparatus does not distribute the symmetric key table. Also, the distribution of the symmetric key table by the base station apparatus is no longer required, so that the frequency usage efficiency can be improved. Also, since the update timing of the symmetric key table is determined at regular intervals, the symmetric key table can be updated on a regular basis. Also, the update timing is determined from the received packet, so that the symmetric key table can be updated in such a manner as to suit the surrounding terminal apparatuses.

Also, since a symmetric key is used to generate a digital signature, the processing amount can be reduced as compared with the case where a public key is used. Also, since the processing amount is reduced, the number of processable packets can be increased. Also, since a symmetric key is used to generate a digital signature, the transmission efficiency can be improved as compared with the case where a public key is used. Also, data such as positional information is not encrypted and therefore the processing amount can be reduced.

The present invention has been described based on the exemplary embodiments. The exemplary embodiments are intended to be illustrative only, and it is understood by those skilled in the art that various modifications to constituting elements and processes as well as arbitrary combinations thereof could be further developed and that such modifications and combinations are also within the scope of the present invention.

In the exemplary embodiments of the present invention, the area where the first symmetric key table is receivable is regarded as a receiving range of the packets from the base station apparatus, and first common table indicates that a list of base station apparatus IDs are contained in the first common table. Instead, the area where the first symmetric key table is used may be expressed by the coordinates. In such a case, the coordinates mean a plurality of coordinate points on the earth, namely the points expressed by the latitude and longitude and, for example, the usable area may be set to an internal region surrounded by a plurality of coordinates. In this case, the first symmetric key table contains a plurality of coordinates specifying the usable area(s) in the list. Also, the regions may be those located the same distance from a given coordinate point. In this case, the first symmetric key table contains one or a plurality of combinations of coordinate and distance, as the information specifying the usable area. Though a description has been given of a case where the first common table may contain a list of information specifying the usable area but this should not be considered as limiting. For example, there may be a list of information specifying an area where the first common table is usable, separately from the first symmetric key table. In this case, the both tables are bounded to each other.

In the exemplary embodiments of the present invention, the communication system 100 defines two kinds of symmetric key tables. However, this should not be considered as limiting and the communication system 100 may define three or more kinds of symmetric key tables. In such a case, a plurality of kinds of first symmetric key tables are defined. A predetermined first symmetric key table is used on the periphery of a predetermined base station apparatus 10, whereas another first symmetric key table is used on the periphery of another base station apparatus 10. By employing this modification, the area where the symmetric key table is to be updated can be further narrowed down.

In the exemplary embodiments of the present invention, the determining unit 68 determines whether an apparatus is located in an area, where the first symmetric key table is usable, or not, based on the identification information on the base station apparatus 10 contained in the packet. However, this should not be considered as limiting and, for example, the determining unit 68 may determine if an apparatus is located in the area where the first symmetric key table is usable, based on the positional information acquired by GPS and the like. By employing this modification, the area where the first symmetric key table is usable can be defined by associating the area with the positional information.

The features and characteristics of the present exemplary embodiment may also be defined by the following Item 1:

### (Item 1)

A radio apparatus comprising:

a communication unit configured to transmit and receive a packet to which a digital signature generated with a symmetric key in a symmetric key cryptosystem is attached;

a storage unit configured to store a symmetric key table that indicates a plurality of kinds of symmetric keys usable for the transmitting and the receiving of the packet in the communication unit;

a selector configured to select any one of symmetric keys from the symmetric key table stored in the storage unit; and

a processing unit configured to verify the digital signature attached to the packet received by the communication unit, with the symmetric key selected by the selector or generating the digital signature attached to the packet to be transmitted from the communication unit,

wherein the processing unit updates the symmetric key table in such a manner that computation is performed on the symmetric key table stored in the storage unit, by using a transform function.

Thereby, the encryption key can be updated autonomously.

What is claimed is:

1. A terminal apparatus comprising:
a storage unit configured to store a received first symmetric key table that indicates a plurality of kinds of symmetric keys, when the first symmetric key table is received, and configured to store in advance a second symmetric key table that is different from the first symmetric key table;
a determining unit configured to determine whether or not said terminal apparatus is present within an area where the first symmetric key table stored in said storage unit is usable;
a generator configured to generate a first packet with a symmetric key contained in the first symmetric key table stored in said storage unit, when said determining unit determines that said terminal apparatus is present within the area, and configured to generate a second packet with a symmetric key contained in the second symmetric key table stored in said storage unit, when said determining unit determines that said terminal apparatus is present outside the area; and
a broadcasting unit configured to broadcast the first packet or the second packet generated by said generator.

2. A terminal apparatus according to claim 1, wherein the plurality of kinds of symmetric keys indicated in the first symmetric key table stored in the storage unit are usable in a restricted area, and
a plurality of kinds of symmetric keys indicated in the second symmetric key table are usable in an area larger than the area where the first symmetric key table is usable.

3. A terminal apparatus according to claim 1, wherein, when said determining unit determines that said terminal apparatus is present within the area, said generator generates a digital signature with the symmetric key contained in the first symmetric key table stored in said storage unit and generates the first packet to which the digital signature is attached, and
when said determining unit determines that said terminal apparatus is present outside the area, said generator generates a digital signature with the symmetric key contained in the second symmetric key table stored in said storage unit and generates the second packet to which the digital signature is attached.

4. A terminal apparatus according to claim 3, further comprising:
a receiving unit configured to receive the second packet broadcast from another terminal apparatus
a verification unit configured to verify the validity of the digital signature with the symmetric key, contained in the second packet received by said receiving unit, for digital signature attached to the second packet received by the receiving unit; and
a processing unit configured to process the second packet received by the receiving unit, when the validity thereof is verified by the verification unit,
wherein said receiving unit receives the first packet broadcast from the another terminal apparatus,
wherein, when the first symmetric key table is stored in said storage unit, said verification unit verifies the validity of the electronic signal with the symmetric key, contained in the first symmetric key table, for the digital signature attached to the first packet received by said receiving unit, and
when the first symmetric key table is not stored in said storage unit and when the digital signature generated with the symmetric key contained in the first symmetric key table is detected a predetermined number of times in a predetermined period of time, said verification unit skips the verification, and
wherein, when the verification unit verifies the validity thereof or when said verification unit skips the verification, the processing unit processes the first packet received by the receiving unit.

5. A base station apparatus for controlling communications between terminal apparatuses, the base station apparatus comprising:
a storage unit configured to store a first symmetric key table that indicates a plurality of kinds of symmetric keys and a second symmetric key table that is different from the first symmetric key table;
a generator configured to generate a packet with a symmetric key contained in the second symmetric key table stored in said storage unit; and
a broadcasting unit configured to broadcast the packet generated by said generator,
wherein said generator generates a packet in which the first common table stored in said storage unit is stored.

6. A base station apparatus according to claim 5, wherein the plurality of kinds of symmetric keys indicated in the first symmetric key table stored in said storage unit are usable in a restricted area, and
a plurality of kinds of symmetric keys indicated in the second symmetric key table are usable in an area larger than the area where the first symmetric key table is usable.
